(19) United States
(12) Patent Application Publication
(10) Pub. No.: US 2026/0320873 A1
(43) Pub. Date: Oct. 15, 2026

(54) VIDEO GENERATION METHOD AND APPARATUS, DEVICE, AND MEDIUM

(71) Applicant: TENCENT TECHNOLOGY (SHENZHEN) COMPANY LIMITED, Shenzhen (CN)

(72) Inventors: Weijie KONG, Shenzhen (CN); Jianbing WU, Shenzhen (CN); Chengfei CAI, Shenzhen (CN); Wenzhe ZHAO, Shenzhen (CN); Bo CUI, Shenzhen (CN); Hongfa WANG, Shenzhen (CN); Wei LIU, Shenzhen (CN); Jie JIANG, Shenzhen (CN)

(73) Assignee: TENCENT TECHNOLOGY (SHENZHEN) COMPANY LIMITED, Shenzhen (CN)

(21) Appl. No.: 19/692,153

(22) Filed: May 29, 2026

Related U.S. Application Data
(63) Continuation of application No. PCT/CN2025/075998, filed on Feb. 6, 2025.

(30) Foreign Application Priority Data
Feb. 9, 2024 (CN) 202410179048.7

(51) Int. Cl. G06T 11/60; G06V 10/82; G06V 20/40

(52) U.S. Cl. CPC G06T 11/60; G06V 10/82; G06V 20/46

(57) ABSTRACT

A video generation method includes performing data noise addition processing on a sample video frame sequence based on a first step quantity and a sample original noise, to obtain video input data; performing text encoding processing on the sample description text, to obtain a sample text encoding feature; acquiring an initial generation model; inputting the video input data into a first spatiotemporal residual component of M spatiotemporal residual components; inputting first embedding information corresponding to the first step quantity into the M spatiotemporal residual components; inputting the sample text encoding feature into the M spatiotemporal attention components; performing, noise prediction on the video input data based on the sample text encoding feature and the first embedding information, to obtain sample predicted noise; and correcting a network parameter of the initial generation model based on the sample original noise and the sample predicted noise.

### CROSS-REFERENCE TO RELATED APPLICATIONS

This application is a bypass continuation application of International Patent Application No. PCT/CN2025/075998, filed on Feb. 6, 2026, which claims priority to and is based on Chinese Patent Application No. 202410179048.7, filed on Feb. 9, 2024, the disclosures of which are incorporated herein in their entireties by reference.

### FIELD

Some embodiments of the present disclosure relate to the field of artificial intelligence technologies, and in particular, to a video generation method and apparatus, a device, and a medium.

### BACKGROUND

A diffusion model may refer to a machine learning model that is configured to generate video data conforming to text content.

For example, a Markov chain of diffusion steps may be defined. A random noise is continuously added to data until pure Gaussian noise data is obtained. Then, a reverse diffusion process is learned, and reverse denoising inference is performed to generate a video. However, a learning capability of current video modeling is limited by a modeling scale, a video is a continuous time sequence, and there is a long-term dependency relationship between video frames. Once a quantity of video frames that need to be generated changes, quality of video generation may be degraded. Accuracy of the machine learning models that generate videos can be improved.

### SUMMARY

Some embodiments of present disclosure provide a video generation method and apparatus, a device, and a medium, which can improve quality of video generation.

According to some embodiments of the present disclosure, a video generation method performed by a computer device includes acquiring a sample video and a sample description text corresponding to the sample video; acquiring a sample video frame sequence from the sample video; determining a first step quantity and sample original noise for the sample video frame sequence; performing data noise addition processing on the sample video frame sequence based on the first step quantity and the sample original noise, to obtain video input data; performing text encoding processing on the sample description text, to obtain a sample text encoding feature; acquiring an initial generation model, the initial generation model comprising M spatiotemporal residual components and M spatiotemporal attention components, and the M spatiotemporal residual components and the M spatiotemporal attention components in the initial generation model being alternately connected, M being an integer greater than 1; inputting the video input data into a first spatiotemporal residual component of the M spatiotemporal residual components; inputting first embedding information corresponding to the first step quantity into the M spatiotemporal residual components; inputting the sample text encoding feature into the M spatiotemporal attention components; performing, in the M spatiotemporal residual components and the M spatiotemporal attention components, noise prediction on the video input data based on the sample text encoding feature and the first embedding information, to obtain sample predicted noise; correcting a network parameter of the initial generation model based on the sample original noise and the sample predicted noise; and determining the initial generation model comprising the corrected network parameter as a video generation model, the video generation model being configured to generate video data matching a video description text.

According to some embodiments of the present disclosure, a video generation apparatus includes at least one memory configured to store computer program code; and at least one processor configured to read the program code and operate as instructed by the program code. The program code includes sample acquisition code configured to cause the at least one processor to, acquire a sample video and a sample description text corresponding to the sample video; acquire a sample video frame sequence from the sample video; and determine a first step quantity and sample original noise for the sample video frame sequence. The program code further includes sample noise addition code configured to cause the at least one processor to, perform data noise addition processing on the sample video frame sequence based on the first step quantity and the sample original noise, to obtain video input data; and perform text encoding processing on the sample description text, to obtain a sample text encoding feature. The program code further includes model acquisition code configured to cause the at least one processor to acquire an initial generation model, the initial generation model comprising M spatiotemporal residual components and M spatiotemporal attention components, and the M spatiotemporal residual components and the M spatiotemporal attention components in the initial generation model being alternately connected, M being an integer greater than 1. The program code further includes sample input code configured to cause the at least one processor to, input the video input data into a first spatiotemporal residual component of the M spatiotemporal residual components; input first embedding information corresponding to the first step quantity into the M spatiotemporal residual components; and input the sample text encoding feature into the M spatiotemporal attention components. The program code further includes noise prediction code configured to cause the at least one processor to perform, in the M spatiotemporal residual components and the M spatiotemporal attention components, noise prediction on the video input data based on the sample text encoding feature and the first embedding information to obtain sample predicted noise. The program code further includes parameter correction code configured to cause the at least one processor to correct a network parameter of the initial generation model based on the sample original noise and the sample predicted noise; and determine the initial generation model comprising the corrected network parameter as a video generation model; the video generation model being configured to generate video data matching a video description text.

According to some embodiments of the present disclosure, a non-transitory computer-readable storage medium, storing computer program code, when executed by at least one processor, causes the at least one processor to at least, acquire a sample video and a sample description text corresponding to the sample video; acquire a sample video frame sequence from the sample video; determine a first step quantity and sample original noise for the sample video frame sequence; perform data noise addition processing on the sample video frame sequence based on the first step quantity and the sample original noise, to obtain video input data; perform text encoding processing on the sample description text, to obtain a sample text encoding feature; acquire an initial generation model, the initial generation model comprising M spatiotemporal residual components and M spatiotemporal attention components, and the M spatiotemporal residual components and the M spatiotemporal attention components in the initial generation model being alternately connected, M being an integer greater than 1; input the video input data into a first spatiotemporal residual component of the M spatiotemporal residual components; input first embedding information corresponding to the first step quantity into the M spatiotemporal residual components; input the sample text encoding feature into the M spatiotemporal attention components; perform, in the M spatiotemporal residual components and the M spatiotemporal attention components, noise prediction on the video input data based on the sample text encoding feature and the first embedding information, to obtain sample predicted noise; correct a network parameter of the initial generation model based on the sample original noise and the sample predicted noise; and determine the initial generation model comprising the corrected network parameter as a video generation model, the video generation model being configured to generate video data matching a video description text.

### BRIEF DESCRIPTION OF THE DRAWINGS

The above and other aspects, features, and advantages of one or more embodiments of the present disclosure will be more apparent from the following description taken in conjunction with the accompanying drawings.

FIG. 1 is a schematic structural diagram of a network architecture according to some embodiments of present disclosure.

FIG. 2 is a schematic diagram of a video generation scenario according to some embodiments of present disclosure.

FIG. 3 is a schematic flowchart I of a video generation method according to some embodiments of present disclosure.

FIG. 4 is a schematic diagram of construction of multi-time-scale input data according to some embodiments of present disclosure.

FIG. 5 is a schematic structural diagram of an initial generation model according to some embodiments of present disclosure.

FIG. 6 is a schematic structural diagram of a spatiotemporal attention component in an initial generation model according to some embodiments of present disclosure.

FIG. 7 is a schematic flowchart of a training phase of an initial generation model according to some embodiments of present disclosure.

FIG. 8 is a schematic diagram of training of an initial generation model according to some embodiments of present disclosure.

FIG. 9 is a schematic flowchart II of a video generation method according to some embodiments of present disclosure.

FIG. 10 is a schematic diagram of sampling of a video generation model according to some embodiments of present disclosure.

FIG. 11 is a schematic flowchart of a sampling phase of a video generation model according to some embodiments of present disclosure.

FIG. 12 is a schematic structural diagram of a video generation apparatus according to some embodiments of present disclosure.

FIG. 13 is a schematic structural diagram of a computer device according to some embodiments of present disclosure.

### DETAILED DESCRIPTION

Technical solutions in embodiments of present disclosure are clearly and completely described in the following with reference to the accompanying drawings in some embodiments of present disclosure. Apparently, the described embodiments are merely some rather than all of some embodiments of present disclosure. Based on some embodiments in present disclosure, all other embodiments obtained by a person of ordinary skill in the art without creative efforts shall fall within the protection scope of present disclosure.

The term, involved in the following description, “some embodiments” describes subsets of all possible embodiments, but “some embodiments” may be the same subset or different subsets of all the possible embodiments and may be combined with each other without conflict.

The operations, techniques, and processes described herein may be implemented via executable instructions or computer program code stored on computer-readable medium. Such computer program code may include distinct portions or modules, where each portion comprises a subset of the total instructions to perform specific operations.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

Terms such as “set” (e.g., “a set of items”) or “subset” unless otherwise noted or contradicted by context, is to be construed as a nonempty collection including one or more members. Further, unless otherwise noted or contradicted by context, term “subset” of a corresponding set does not necessarily denote a proper subset of corresponding set, but subset and corresponding set may be equal.

An expression, “a and/or b” may be understood as including only a, only b and both a and b. Expressions “at least one of a, b, and c” and “at least one of a, b, or c” may be understood as including only a, only b, only c, both a and b, both a and c, both b and c, or all of a, b, and c. Also, expressions such as ‘a, b, or c’ may be understood as ‘at least one of a, b, or c’ unless explicitly stated otherwise, or unless the elements would only be understood as alternatives by a person ordinarily skilled in the art.

Further, unless stated otherwise or otherwise clear from context, phrase “based on” may refer to “based at least in part on” and not “based solely on.”

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

With regard to the description of the drawings, similar reference numerals may be used to refer to similar or related components.

Some embodiments of present disclosure relate to a video content generation technology within an artificial intelligence generated content technology, and more specifically to a video generation diffusion model based on multi-time-scale modeling (hereinafter referred to simply as a video generation model for ease of understanding). In a training phase, videos with different quantities of frames are used for model training, enabling the video generation model to capture long-term and short-term temporal action information during the training. Learning and modeling of the temporal action information is more comprehensive. Consequently, the trained video generation model can generate videos of different durations, and can ensure that video pictures have consistency and motion coherence at any duration, thereby improving quality of video generation. The diffusion model may include a diffusion process and a reverse diffusion process. The diffusion process represents a process of gradually adding noise to an image (or a video). The reverse diffusion process represents a process of performing stepwise denoising on noise, restoring an original image (or video) from the noise.

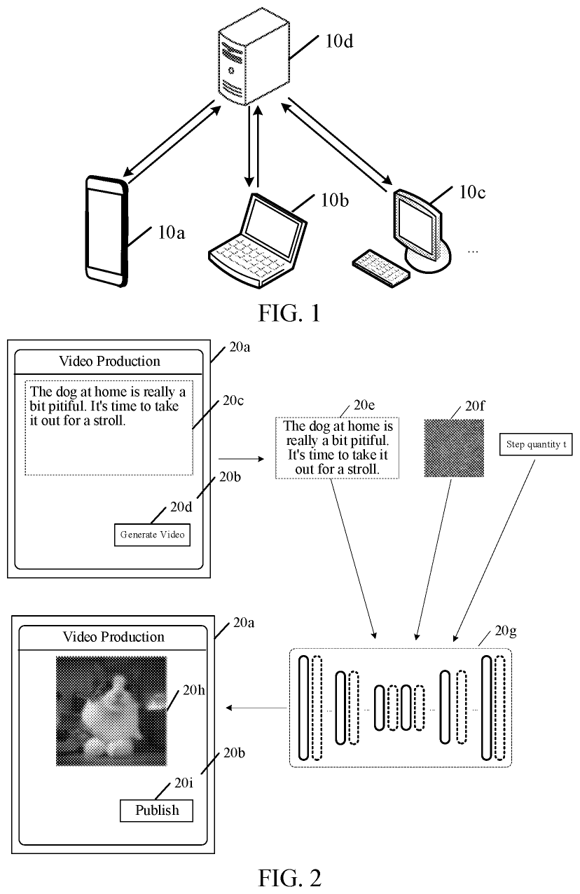

Referring to FIG. 1, FIG. 1 is a schematic structural diagram of a network architecture according to some embodiments of present disclosure. The network architecture may include a server 10d and a terminal cluster. The terminal cluster may include one or more terminal devices. A quantity of terminal devices included in the terminal cluster is not limited herein. As shown in FIG. 1, the terminal cluster may include a terminal device 10a, a terminal device 10b, a terminal device 10c, and the like. All terminal devices in the terminal cluster (for example, which may include the terminal device 10a, the terminal device 10b, the terminal device 10c, and the like) may have a network connection to the server 10d, so that the terminal devices may exchange data with the server 10d by using the network connection.

The terminal devices in the terminal cluster may include electronic devices such as smart phones, tablet computers, notebook computers, palmtop computers, mobile internet devices (MIDs), wearable devices (such as smart watches or smart bracelets), smart voice interaction devices, smart home appliances (such as smart TVs), in-vehicle devices, and aircrafts. Types of the terminal devices are not limited in present disclosure. A service application may be installed on each terminal device in the terminal cluster shown in FIG. 1. When running on the terminal devices, the service applications may separately exchange data with the server 10d shown in FIG. 1. The service application running on each terminal device may correspond to an independent client, or may correspond to an embedded sub-client integrated into a client, which is not limited in present disclosure.

The service application may include, but is not limited to, an application having a video content generation function such as a browser, an in-vehicle application, a smart home application, an entertainment application (such as a game application), a multimedia application (such as a video application or a short video application), and a conference application. If the terminal device included in the terminal cluster is an in-vehicle device, the in-vehicle device may be an intelligent terminal in a smart traffic scenario, and a service application running on the in-vehicle device may be referred to as an in-vehicle application.

The server 10d may be an independent physical server, or a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), and big data and artificial intelligence platforms. The type of the server is not limited in present disclosure.

The service application installed in each terminal device shown in FIG. 1 may invoke a pre-trained video generation model. For example, the trained video generation model may be launched in the service application. If an object A wants to create video data for publication on a content interaction platform, the object A may upload a desired video description text to a service application installed on a terminal device (e.g., the terminal device 10a). In some embodiments, the object A may alternatively set a desired video duration in the service application. The video description text involved in this embodiment of present disclosure may be a natural statement configured for describing video content that the object wants to create. The video description text may include, but is not limited to, a product text description, a story or emotion expression text, a film and television script, a news release, teaching content, medical information, and the like.

The terminal device 10a may acquire the video description text uploaded by the object A, and invoke the video generation model in the service application. Random Gaussian noise may be generated according to the video duration set by the object A, and the foregoing video generation model is continuously used for noise prediction by taking the Gaussian noise as a start point and with reference to a video text encoding feature corresponding to the video description text given by the object A. By using predicted video predicted noise, denoising processing is performed on the Gaussian noise inputted into the video generation model to obtain a video with less noise until the noise is completely removed, obtaining target video data matching the video description text. The object A may publish the generated target video data to the content interaction platform.

For ease of understanding, the foregoing video generation model may refer to a video generation diffusion model configured to generate a video generation diffusion model conforming to specified video description text content. The video generation diffusion model in a training phase (e.g., a video generation diffusion model that has not been trained) may be referred to as an initial generation model, and the video generation diffusion model in a sampling phase (a video generation diffusion model that has been trained) may be referred to as a video generation model. The initial generation model and the video generation model are the video generation diffusion model in different phases. For example, the initial generation model and the video generation model have the same network structure. A video generation procedure involved in this embodiment of present disclosure may include a training phase and a sampling phase of a model.

In the training phase, different degrees of Gaussian noise may be gradually added to an input sample video frame sequence, and a process of adding Gaussian noise to the sample video frame sequence may be referred to as a forward process (which may also be referred to as a diffusion process) of the sample video frame. Then, noisy data, a step quantity t (the step quantity herein may be a quantity of times of noise diffusion of the noisy data based on the sample video frame sequence), and a sample text encoding feature (which may also be referred to as a text condition) encoded by a text encoder may be inputted into the initial generation model. Noise added to the step quantity t (e.g., sample predicted noise) is predicted by using the initial generation model. A loss is calculated between the sample predicted noise and the noise actually added in the forward process to optimize the initial generation model.

In the sampling phase, iterative denoising is performed by using the trained video generation model, the trained video generation model is continuously used to predict noise by taking random Gaussian noise as a start point and with respect to a video text encoding feature corresponding to a given video description text, and the Gaussian noise may be transformed into video data with less noise by stepwise denoising until the noise is completely removed, to obtain target video data conforming to the video description text, thereby implementing a text-to-video task.

A process of training the initial generation model by using video data and a video description text corresponding thereto and a process of automatically generating the target video data by using the video generation model may be performed by a computer device. The computer device may be the server 10d in the network architecture shown in FIG. 1 (the server 10d may be a backend server corresponding to the service application), or may be any terminal device in the terminal cluster, or may be a computer program (including program code, for example, an application client of a service application installed in the terminal device), or the like, which is not limited in present disclosure.

The trained video generation model, as an automatic video content generation technology, may be applied to application scenarios such as advertising creative production, interactive media content generation, film and television production, news reporting, online education, health care, and gaming, to improve video generation efficiency; or may be applied to computer vision scenarios such as text-to-video, image-to-video, video editing, text-to-image, text generation, and video content understanding. The application scenario of the video generation model is not limited in present disclosure.

For example, in the scenario of advertising creative production, the video generation model may be used to help a material placement object (e.g., an advertiser) quickly create a product introduction video. The material placement object only needs to provide a text description of a product. Video data including elements such as a product picture, a usage scenario, and usage evaluation may be automatically generated by using the video generation model, facilitating a consumer to understand an exhibit more intuitively and enhancing product image and appeal.

In the scenario of interactive media content generation, interesting and attractive video content may be created by using the video generation model. For example, any object may input a piece of text content of a story or emotional expression, and the text content may be converted, by using the video generation model, into a piece of target video data including a related picture, music, and an animation, so that interactive content is more vivid and interesting, and interactivity of an object in the content interaction platform is improved.

In the scenario of film and television production, when content of a script is given, the script may be converted, by using the video generation model, into a high-quality video shot, thereby improving production efficiency of a movie or an animation.

In the scenario of news reporting, after a news editor completes a news release, text content of the news release may be automatically converted, by using the video generation model, into video news including elements such as a related picture, a video clip, and background music, thereby improving news publication efficiency. Secondly, a user may choose to read text news or may choose to watch video news generated from the news release, which may provide a richer information acquisition manner.

In the scenario of online education, a teacher only needs to provide text of teaching content, and the text of the teaching content may be automatically converted, by using the video generation model, into a teaching video including elements such as a related image, an animation, and a commentary. This can not only save time of the teacher, but also improve attractiveness of the teaching content, helping students better understand and remember the teaching content.

In the scenario of health care, a doctor may explain complex medical information such as a disease and a treatment plan by using the video generation model. For example, the doctor may input a description text of the disease, and a video including a related image, an animation, and a commentary may be generated by using the video generation model, to help a patient and a family to better understand the disease and the treatment plan.

In the scenario of gaming, a game developer may input a requirement text, and a video including a game virtual character, an animation, and a game scenario may be generated by using the video generation model, thereby improving game development efficiency of the game developer. In some embodiments, a game enthusiast may input a game clearance commentary text, and a video including a game scenario animation, a clearance operation, and a clearance commentary may be generated by using the video generation model, helping the game enthusiast improve production efficiency of a game commentary video. In some embodiments, the video generation model may further be applied to other scenarios of gaming, which is not limited in present disclosure.

An application process of the trained video generation model is described below by taking the scenario of interactive media content generation as an example. Referring to FIG. 2, FIG. 2 is a schematic diagram of a video generation scenario according to some embodiments of present disclosure. As shown in FIG. 2, when wanting to produce video data in a content interaction platform, the object A may launch a content interaction platform in a terminal device 20a, and perform a trigger operation on a “Video Production” control in the content interaction platform. In this case, the terminal device 20a may display a video production page 20b in the content interaction platform in response to the trigger operation on the “Video Production” control. The video production page 20b may include a text input region 20c and a “Generate Video” control 20d.

The object A may edit text content in the text input region 20c, and upon completion of editing, may perform a trigger operation on the “Generate Video” control 20d on the video producing page 20b. In this case, the terminal device 20a may determine, in response to the trigger operation on the “Generate Video” control 20d, the text content edited by the object A in the text input region 20c as a video description text 20e for producing video data, and invoke a video generation model 20g in the content interaction platform. A network structure of the video generation model 20g is to be described in subsequent operations.

The terminal device 20a may randomly initialize Gaussian noise 20f (which may also be referred to as initialized noise). Dimensions of the Gaussian noise 20f may be represented as B′×S″×3×H×W. Herein, B′ may represent a quantity of videos to be generated, S″ may represent a quantity of duration frames of a video to be generated (which may also be referred to as a quantity of video frames), H may represent a height of the video to be generated, and W may represent a width of the video to be generated. A step quantity t corresponding to the Gaussian noise 20f may be sampled, and step quantity encoding information corresponding to the step quantity t is acquired. The step quantity encoding information corresponding to the step quantity t has the same dimensions as the above Gaussian noise 20f. The step quantity t herein may be represented as a degree of noise addition, and a total quantity of diffusion steps TS may be preset for the video generation model. The step quantity t may be any integer randomly sampled from [1, TS]. For example, assuming that the total quantity of diffusion steps TS is set to 1000, the step quantity t may be any value from 1 to 1000. The terminal device 20a may perform text encoding processing on the video description text 20e by using the text encoder, to obtain a video text encoding feature corresponding to the video description text 20e.

Further, the Gaussian noise 20f, the video text encoding feature corresponding to the video description text 20e, and the step quantity encoding information corresponding to the step quantity t may be inputted into the video generation model 20g. Video predicted noise is obtained by using a forward process of the video generation model 20g. Denoising processing may be performed on the Gaussian noise 20f according to the video predicted noise, to obtain noisy video data corresponding to a step quantity t−1. The noisy video data corresponding to the step quantity t−1 may be inputted into the video generation model 20g, and the foregoing denoising process is repeated. In some embodiments, alternatively, noisy video data corresponding to a step quantity t−τ may be obtained through sampling according to the video predicted noise. Herein, τ may be any integer greater than 1. In this way, video sampling efficiency can be improved. Through stepwise denoising processing on the Gaussian noise 20f, noise-free target video data 20h conforming to the video description text 20e is generated, which can improve video generation efficiency. The target video data 20h finally generated may be displayed on the video production page 20b. The object A may perform a trigger operation on a “Publish” control 20i on the video production page 20b, to publish the target video data 20h on the content interaction platform, so that a user on the content interaction platform participates in interaction with the target video data 20h, thereby improving interactivity of content published on the content interaction platform.

The step quantity t may be represented as a degree of noise addition in the training phase. The step quantity t may be represented as a degree of denoising in the sampling phase. Whether in the training phase or the sampling phase, the same step quantity t represents the same meaning. In some embodiments, for ease of understanding, the step quantity t in the training phase may be referred to as a diffusion step quantity, and the step quantity t in the sampling phase may be referred to as a denoising step quantity, which is not limited in present disclosure.

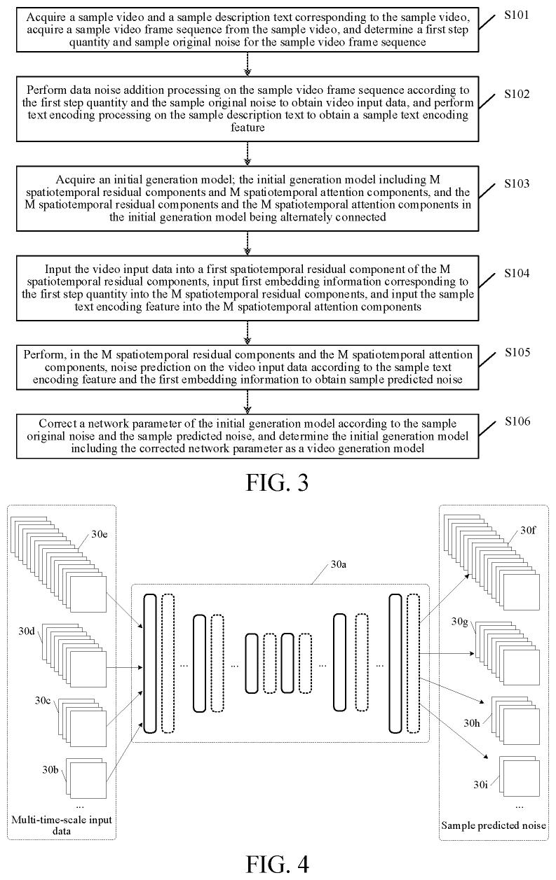

Referring to FIG. 3, FIG. 3 is a schematic flowchart I of a video generation method according to some embodiments of present disclosure. The video generation method may be performed by a computer device. The computer device may be a server (the server 10d shown in FIG. 1) or may be a terminal device (any terminal device in the terminal cluster shown in FIG. 1), which is not limited in present disclosure. As shown in FIG. 3, the video generation method may include the following operation S101 to operation S106:

Operation S101: Acquire a sample video and a sample description text corresponding to the sample video, acquire a sample video frame sequence from the sample video, and determine a first step quantity and sample original noise for the sample video frame sequence.

In this embodiment of present disclosure, in the training phase, a batch of videos and corresponding video text descriptions may be collected to form (video, text) pairs, for training an initial generation model. For ease of understanding, in this embodiment of present disclosure, a video used for training the initial generation model may be referred to as a sample video, and a video description text corresponding to the sample video may be referred to as a sample description text.

Frame extraction processing may be performed on the sample video, an initial video frame sequence with a fixed quantity of frames is extracted from the sample video, and initial video frame sequences corresponding to one or more sample videos may form a sample video frame sequence tensor. For example, a frame extraction interval duration corresponding to the sample video may be determined according to a video frame quantity threshold and a video duration corresponding to the sample video. The frame extraction interval duration may represent a time interval at which two video frames are consecutively extracted from the sample video. A plurality of video frames are acquired from the sample video according to the frame extraction interval duration (for example, a fixed quantity of video frames are extracted from the sample video), and the plurality of video frames are combined into an initial video frame sequence. A quantity of video frames included in the initial video frame sequence is equal to the video frame quantity threshold. The video frame quantity threshold may represent a maximum quantity of video frames supported by the initial generation model, or may understood as a maximum length of video frames supported. The video frame quantity threshold may be customized according to an actual scenario requirement, which is not limited in present disclosure.

The sample video frame sequence for training the initial generation model may be acquired from the initial video frame sequence. The sample video frame sequence may be any subsequence, whose quantity of video frames is less than or equal to the video frame quantity threshold, of the initial video frame sequence. The subsequence herein may refer to a sequence including all or part of the video frames in the initial video frame sequence. For example, the quantity of video frames included in the sample video frame sequence for training the initial generation model is not limited in this embodiment of present disclosure. For example, a multi-time-scale sample video frame sequence may be acquired from one initial video frame sequence.

In some embodiments, the initial video frame sequences corresponding to the one or more sample videos may form a video frame sequence tensor with dimensions of B×S₀×3×H×W, where B, S₀, H, and W respectively represent a batch size, a video frame quantity threshold supported by the initial generation model, a video frame height, and a video frame width. In the training phase of the initial generation model, distributed training may be performed on the initial generation model. At each training step, initial input (a sample video frame sequence) of the initial generation model on each graphics processing unit (GPU) (rank, which may be represented as a set of memory chips) may be an initial video frame sequence with dimensions of B×S₀×3×H×W. To implement multi-time-scale modeling, each rank may randomly extract sample video frame sequences having different quantities of video frames from the initial video frame sequence with the dimensions of B×S₀×3×H×W. Dimensions of the sample video frame sequence may be denoted as B×S×3×H×W, S∈[1, S₀], where S represents any value less than or equal to the video frame quantity threshold S₀, for representing a quantity of video frames selected from the initial video frame sequence. For example, the initial generation model may be trained by using the sample video frame sequences having different quantities of video frames, so that the initial generation model can efficiently capture long-term and short-term temporal action information during the training, making earning and modeling of the temporal action information more comprehensive.

Referring to FIG. 4, FIG. 4 is a schematic diagram of construction of multi-time-scale input data according to some embodiments of present disclosure. After an initial video sequence with a fixed So of frames is extracted from a sample video, sample video frame sequences of different durations may be randomly extracted from the initial video frame sequence, e.g., sample video frame sequences having different quantities of video frames are randomly extracted, to obtain multi-time-scale input data for training the initial generation model. As shown in FIG. 4, the multi-time-scale input data may include a sample video frame sequence 30b, a sample video frame sequence 30c, a sample video frame sequence 30d, a sample video frame sequence 30e, and the like that have different quantities of video frames. The multi-time-scale input data may be used as initial input to the initial generation model 30a, and noise prediction may be performed on the sample video frame sequences by using the initial generation model 30a, to obtain sample predicted noise respectively corresponding to the sample video frame sequences.

For example, after noise prediction is performed on the sample video frame sequence 30b, sample predicted noise 30i may be obtained, and the sample predicted noise 30i has the same dimensions as the sample video frame sequence 30b. After noise prediction is performed on the sample video frame sequence 30c, sample predicted noise 30h may be obtained, and the sample predicted noise 30h has the same dimensions as the sample video frame sequence 30c. After noise prediction is performed on the sample video frame sequence 30d, sample predicted noise 30g may be obtained, and the sample predicted noise 30g has the same dimensions as the sample video frame sequence 30d. After noise prediction is performed on the sample video frame sequence 30e, sample predicted noise 30f may be obtained, and the sample predicted noise 30f has the same dimensions as the sample video frame sequence 30e. For example, dimensions of input and output of the initial generation model 30a are the same. A network structure of the initial generation model 30a and a noise prediction process of the initial generation model 30a are to be described in subsequent operations.

Further, data noise addition processing may be performed on the above sample video frame sequences to obtain noisy data. To be specific, in the training phase, noise may be added to the sample video frame sequence for training the initial generation model, and the noise-added data is inputted into the initial generation model. In this embodiment of present disclosure, the noise-added data may be referred to as video input data. For example, a diffusion parameter (which may be denoted as T_{S}) corresponding to the initial generation model may be acquired. According to the diffusion parameter T_{S}, a first step quantity corresponding to the sample video frame sequence may be sampled. The diffusion parameter is configured for representing a total quantity of diffusion steps of the initial generation model, and the first step quantity is less than or equal to the diffusion parameter. Gaussian noise having the same dimensions as the sample video frame sequence may be generated, and the Gaussian noise is determined as sample original noise corresponding to the sample video frame sequence.

In a feasible implementation, a step quantity t1 (for ease of understanding, the step quantity t1 herein may be referred to as a first step quantity) may be randomly sampled according to a denoising diffusion probabilistic model (DDPM), and Gaussian noise having the same dimensions as the sample video frame sequence is randomly generated. The Gaussian noise herein may be used as sample original noise added to the sample video frame sequence. The first step quantity t1 may be configured for representing a degree of noise addition of the sample video frame sequence. The first step quantity t1 may be any integer value within a range of [1, T_{S}], where T_{S} herein may be a preset diffusion parameter, and the diffusion parameter T_{S} may be configured for representing a total quantity of diffusion steps of the initial generation model. For example, when the total quantity of diffusion steps (the diffusion parameter T_{S}) is set to 1000, the first step quantity t1 may be any value within [1, 1000]. For example, t1 may be any value such as 100, 500, 900, or 1000. The sample original noise is Gaussian noise that has the same dimensions as the sample video frame sequence and is generated by random sampling from a standard normal distribution N(0, 1).

The DDPM may include two processes: a forward process and a reverse process. The forward process may also be referred to as a diffusion process, which may be understood as that through T_{S} times (T_{S} herein may refer to a preset total quantity of times of diffusion, for example, T_{S} may be any value such as 1000 or 500, which is not limited in present disclosure) of noise addition, a small amount of random noise is added during each diffusion, gradually adding noise to an input original image or video to form a normal distribution, thereby transforming the original image or video into isotropic noise. The forward process may be understood as data noise addition, and the reverse process may be understood as a denoising process. Therefore, the reverse process may be referred to as a denoising process. Noise removal is performed through T_{S} times of reverse prediction, and the noise is gradually restored to a noise-free original image or video through multiple iterations. For example, the reverse process may be understood as a process of generating data. The DDPM may implement estimation of the noise by using the forward process and the reverse process, thereby restoring the noise to the original image or video.

A key to the DDPM is noise prediction. In this embodiment of present disclosure, a conditional model (e.g., a 3D U-Net obtained through multi-time-scale modeling) may be used as a model for predicting noise. By training the 3D U-Net model, noise predicted (e.g., sample predicted noise) is made close to noise actually added (e.g., sample original noise). The 3D U-Net model adopts a network structure including downsampling and upsampling. For example, a network structure of the 3D U-Net model may include, but is not limited to, a convolutional neural network (CNN), a feedforward neural network, a long short-term memory (LSTM) network, a recurrent convolutional neural network (RCNN), an attention mechanism, a variational autoencoder (VAE), a variation of any of the above network structures, or a combination of any two or more of the above network structures, and the like. The network structure of the 3D U-Net model is not limited in this embodiment of present disclosure.

The initial generation model in this embodiment of present disclosure may be considered as a diffusion model, and the training phase thereof is essentially a training process of the 3D U-Net model.

Operation S102: Perform data noise addition processing on the sample video frame sequence according to the first step quantity and the sample original noise to obtain video input data, and perform text encoding processing on the sample description text to obtain a sample text encoding feature.

For example, a sequence weight corresponding to the sample video frame sequence may be determined according to the first step quantity, an original noise weight corresponding to the sample original noise may be determined according to the sequence weight, and a sum of squares of the sequence weight and the original noise weight is 1. The video input data may be obtained by adding a product of the sequence weight and the sample video sequence and a product of the original noise weight and the sample original noise. The video input data may be inputted into the initial generation model.

When the diffusion parameter T_{S} (e.g., a total quantity of diffusion steps) is set, a hyperparameter

$${\{ {β}_{t} \}}_{t = 1}^{{T}_{s}}$$

may be preset for the diffusion parameter T_{S}. The hyperparameter

$${\{ {β}_{t} \}}_{t = 1}^{{T}_{s}}$$

may be referred to as a noise schedule. βₜ represents a diffusion rate corresponding to the step quantity t. The noise schedule may include a diffusion rate corresponding to each step quantity, and t may be a value of 1, 2, . . . , or T_{S}. In the forward process, the diffusion rate βₜ may increase stepwise as the step quantity increases. As the diffusion rate βₜ increases, a proportion of noise may become larger and larger, which may be roughly seen as a stepwise increase from 0 to 1.

The foregoing sequence weight may be determined according to the first step quantity and diffusion rates corresponding to all step quantities less than the first step quantity. When the first step quantity is denoted as t1, the sequence weight may be represented as

$${α}_{t 1} = \sqrt{{Π}_{t = 1}^{t 1} {β}_{t}} ,$$

and the original noise weight may be represented as

$${σ}_{t 1} = \sqrt{1 - {α}_{t 1}^{2}} .$$

For example, when the first step quantity is 100, the sequence weight may refer to a result obtained by cumulatively multiplying diffusion rates respectively corresponding to the first 100 step quantities and taking a square root of a cumulative multiplication result. For the obtained sample video frame sequence x₀, data noise addition processing may be performed on the sample video frame sequence x₀ according to the randomly sampled first step quantity t1 and randomly generated sample original noise (which may be denoted as ε) to obtain noise-carrying video input data xₜ₁. The video input data xₜ₁ may be shown in Formula (1):

xₜ₁=αₜ₁x₀=σₜ₁∈,∈~N(0,1) (1)

After the sequence weight at and the original noise weight σₜ₁ are obtained, weighted summation may be performed on the sample video frame sequence and the sample original noise according to Formula (1), to obtain the video input data xₜ₁ for input to the initial generation model.

For the sample description text corresponding to the sample video, text feature extraction may be performed on the sample description text by using the text encoder, to obtain the sample text encoding feature corresponding to the sample description text. In one or more embodiments, in a process of performing text feature extraction on the sample description text by using the text encoder, word segmentation processing may be performed on the sample description text to obtain a plurality of unit characters (the unit character herein may be a single word or a single phrase in the sample description text), and then each unit character may be vectorized to obtain a vector representation corresponding to the unit character. For example, one-hot encoding may be used for vector representation of each unit character, or word2vec (a word vector model) may be used for vector representation of each unit character, which is not limited in present disclosure. The vector representations corresponding to the unit characters included in the sample description text may be combined to obtain an initial text feature corresponding to the sample description text. The initial text feature is inputted into the text encoder, feature extraction (such as encoding processing) is performed on the initial text feature by using the text encoder, and the sample text encoding feature corresponding to the sample description text may be outputted.

A network structure of the text encoder may include, but is not limited to, current text processing models, which may be, for example, a contrastive language-image pre-training (CLIP) model, a transfer text-to-text transformer (T5), a bidirectional encoder representation from transformers (BERT, a natural language processing model) structure, a BART structure (a natural language processing model improved based on BERT) structure, a recurrent neural network (RNN), a long short-term memory (LSTM) network, or the like, or may be a variation of any one of the foregoing natural language processing networks, or a combination of any two or more of the foregoing networks. The network structure of the text encoder is not limited in present disclosure. The text encoder involved in this embodiment of present disclosure may be a pre-trained text encoder, for example, a text encoder that has been trained in advance; or may be a text encoder that needs to be trained in the training phase of the initial generation model, which is not limited in present disclosure.

A process of processing the sample description text by using the text encoder may include, but is not limited to, dividing the sample description text into D unit characters, and obtaining unit word vectors respectively corresponding to the D unit characters. D is a positive integer. For example, D may be a value of 1, 2, . . . . Text vectors respectively corresponding to the D unit characters are acquired according to semantic information of the D unit characters in the sample description text. Position vectors respectively corresponding to the D unit characters are acquired according to text positions of the D unit characters in the sample description text. The unit word vectors, the text vectors, and the position vectors are combined (the combination herein may be understood as vector addition) to obtain the initial text feature corresponding to the sample description text. The initial text feature is inputted into the text encoder, and encoding processing is performed on the initial text features by using the text encoder, to obtain the sample text encoding feature corresponding to the sample description text.

The computer device may convert each unit character in the sample description text into a word vector (e.g., a unit word vector) by querying a word vector table. The word vector table may include word vectors corresponding to all common characters. The word vector table may be understood as a “dictionary” including all common character vectors. The unit character may refer to a single word or a single phrase in the sample description text. The text vectors may be configured for describing global semantic information of the sample description text, and may be fused with the unit word vectors. Since semantic information carried by unit characters appearing at different positions in the sample description text is different (for example, “I wait for you” and “You wait for me” carry different semantic information), different position vectors may be respectively attached to the D unit characters in the sample description text for distinction. Further, the unit word vectors, the text vectors, and the position vectors may be added, and a result of the addition is used as the initial text feature corresponding to the sample description text.

Operation S103: Acquire an initial generation model; the initial generation model including M spatiotemporal residual components and M spatiotemporal attention components, and the M spatiotemporal residual components and the M spatiotemporal attention components in the initial generation model being alternately connected.

Operation S104: Input the video input data into a first spatiotemporal residual component of the M spatiotemporal residual components, input first embedding information corresponding to the first step quantity into the M spatiotemporal residual components, and input the sample text encoding feature into the M spatiotemporal attention components.

In this embodiment of present disclosure, the training phase of the initial generation model may essentially be understood as training of the 3D U-Net model. A 3D U-Net in the initial generation model may include M spatiotemporal residual components and M spatiotemporal attention components. The M spatiotemporal residual components and the M spatiotemporal attention components may be alternately connected in the 3D U-Net of the initial generation model. M is an integer greater than 1. A value of M, e.g., a depth of the 3D U-Net, is not limited in this embodiment of present disclosure. The 3D U-Net in the initial generation model may be an encoder (downsampling)-decoder (upsampling) structure. The alternating connection between the M spatiotemporal residual components and the M spatiotemporal attention components may be understood as connecting every two spatiotemporal residual components by using one spatiotemporal attention component. Similarly, except for the last spatiotemporal attention component in the initial generation model, in the remaining M−1 spatiotemporal attention components, every two spatiotemporal attention components may be connected by using one spatiotemporal residual component. For example, assuming that the initial generation model includes 3 spatiotemporal residual components and 3 spatiotemporal attention components (in which case the value of M is 3), a connection relationship between these 3 spatiotemporal residual components and 3 spatiotemporal attention components may be represented as: the 1^{st} spatiotemporal residual component→the 1^{st} spatiotemporal attention component→the 2^{nd} spatiotemporal residual component→the 2^{nd} spatiotemporal attention component→the 3^{rd} spatiotemporal residual component→the 3^{rd} spatiotemporal attention component.

The video input data may be used as input data of the 3D U-Net in the initial generation model. Certainly, in addition to the video input data, the input data of the 3D U-Net may further include a sample text encoding feature and first embedding information (time embedding) corresponding to the first step quantity. The video input data may be directly inputted into the first spatiotemporal residual component in the initial generation model. The first embedding information may be inputted into each spatiotemporal residual component in the initial generation model to guide a degree of noise prediction of the 3D U-Net in the initial generation model. The sample text encoding feature may be inputted into each spatiotemporal attention component in the initial generation model, which may be configured for guiding noise prediction of the 3D U-Net in the initial generation model. If the sample text encoding feature corresponding to the sample description text is introduced in the training phase of the initial generation model, the noise prediction of the initial generation model in this case may be called conditional generation with text.

In some embodiments, in the training phase, a drop operation may be randomly performed on the sample description text at a probability p. The drop operation herein may be understood as that the sample description text is changed to an empty string, or may be understood as that the sample text encoding feature is zeroed and changed to a zero vector. In this case, the noise prediction of the initial generation model may be referred to as unconditional generation without text. The above probability p may be any value set according to an actual requirement, which is not limited in present disclosure.

The sample text encoding feature corresponding to the sample description text may be configured for guiding the noise prediction of the 3D U-Net, and the initial generation model is trained to support text-conditioned noise prediction. The 3D U-Net shares a parameter, so time embedding is needed to remind the model of a current step quantity, to guide a degree of sample predicted noise outputted by the 3D U-Net. The first step quantity may be converted into an initial diffusion vector. For example, one-hot encoding may be used for vector representation of the first step quantity, or another encoding manner may be used for vector representation of the first step quantity, which is not limited in present disclosure. Further, encoding processing may be performed on the initial diffusion vector corresponding to the first step quantity by using one or more fully connected layers, to obtain the first embedding information corresponding to the first step quantity. The first embedding information herein may refer to step quantity encoding information corresponding to the first step quantity.

The video input data, the first embedding information, and the sample text encoding feature may be separately inputted into the initial generation model; or the video input data and the first embedding information may be concatenated, and the sample text encoding feature and a feature obtained through concatenation are separately inputted into the initial generation model, which is not limited in present disclosure.

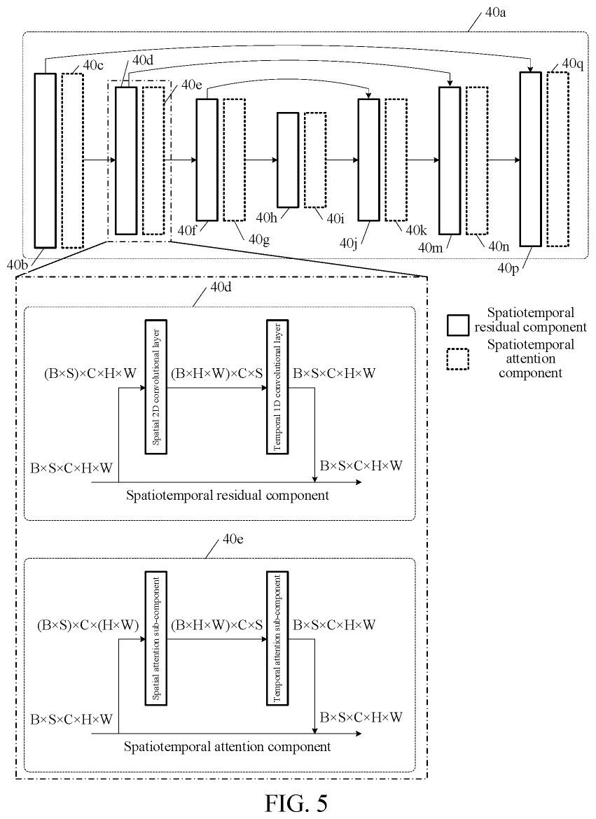

Referring to FIG. 5, FIG. 5 is a schematic structural diagram of an initial generation model according to some embodiments of present disclosure. In this embodiment of present disclosure, a network structure of the initial generation model is described by using an example in which the initial generation model includes 7 spatiotemporal residual components and 7 spatiotemporal attention components (in which case the value of M is 7). The foregoing 7 spatiotemporal residual components and 7 spatiotemporal attention components may constitute a 3D U-Net model in the initial generation model. As shown in FIG. 5, the 7 spatiotemporal residual components in the initial generation model 40a are respectively a spatiotemporal residual component 40b, a spatiotemporal residual component 40d, a spatiotemporal residual component 40f, a spatiotemporal residual component 40h, a spatiotemporal residual component 40j, a spatiotemporal residual component 40m, and a spatiotemporal residual component 40p. The 7 spatiotemporal attention components in the initial generation model 40a are respectively a spatiotemporal attention component 40c, a spatiotemporal attention component 40e, a spatiotemporal attention component 40g, a spatiotemporal attention component 40i, a spatiotemporal attention component 40k, a spatiotemporal attention component 40n, and a spatiotemporal attention component 40q. The 7 spatiotemporal residual components and the 7 spatiotemporal attention components are alternately connected. The spatiotemporal residual components in the initial generation model 40a may have the same network structure, and the attention components in the initial generation model 40a may have the same network structure.

For ease of understanding, structures of the spatiotemporal residual component and the spatiotemporal attention component are described below by taking the spatiotemporal residual component 40d and the spatiotemporal attention component 40e in the initial generation model 40a as examples. As shown in FIG. 5, the spatiotemporal residual component 40d may include a spatial 2D convolutional layer (which may be referred to simply as a spatial convolutional layer) and a temporal 1D convolutional layer (which may be referred to simply as a temporal convolutional layer). The temporal convolutional layer supports input of an arbitrary length, thus being compatible with video input data with different quantities of frames, so that the initial generation model can capture long-term and short-term temporal action information during the training. It is assumed that dimensions of input data of the spatiotemporal residual component 40d are B×S×C×H×W, where B represents a batch size, S represents a quantity of video frames in the sample video frame sequence, C represents a quantity of channels, H represents a video height, and W represents a video width. Then, the input data with the dimensions of B×S×C×H×W may be reshaped into data with dimensions of (B×S)×C×H×W, and the data with the dimensions of (B×S)×C×H×W is inputted into the spatial convolutional layer of the spatiotemporal residual component 40d. Output of the spatial convolutional layer in the spatiotemporal residual component 40d may be reshaped into data with dimensions of (B×H×W)×C×S, and the data with the dimensions of (B×H×W)×C×S is inputted into the temporal convolutional layer of the spatiotemporal residual component 40d. Finally, dimensions of the output of the spatiotemporal residual component 40d are converted to B×S×C×H×W.

One or more spatial convolutional layers and one or more temporal convolutional layers in each spatiotemporal residual component included in the initial generation model 40a may be provided. Specific structures of the spatial convolutional layers and the temporal convolutional layers in each spatiotemporal residual component are not limited in present disclosure. Residual connections may alternatively be performed between the spatiotemporal residual components in the initial generation model 40a. For example, a residual connection may be established between two spatiotemporal residual components symmetrically positioned in the initial generation model 40a. For example, the spatiotemporal residual component 40b and the spatiotemporal residual component 40p are symmetrically positioned in the initial generation model 40a. A residual connection may be established between the spatiotemporal residual component 40b and the spatiotemporal residual component 40p, e.g., output of the spatiotemporal residual component 40b may serve as input to the spatiotemporal residual component 40p. The spatiotemporal residual component 40d and the spatiotemporal residual component 40m are symmetrically positioned in the initial generation model 40a, and a residual connection may be established between the spatiotemporal residual component 40d and the spatiotemporal residual component 40m, e.g., output of the spatiotemporal residual component 40d may serve as input to the spatiotemporal residual component 40m. The spatiotemporal residual component 40f and the spatiotemporal residual component 40j are symmetrically positioned in the initial generation model 40a, and a residual connection may be established between the spatiotemporal residual component 40f and the spatiotemporal residual component 40j, e.g., output of the spatiotemporal residual component 40f may serve as input to the spatiotemporal residual component 40j.

As shown in FIG. 5, the spatiotemporal attention component 40e may include a spatial attention sub-component and a temporal attention sub-component. The temporal attention sub-component supports input of an arbitrary length, thus being compatible with video input data with different quantities of frames, so that the initial generation model can capture long-term and short-term temporal action information during the training. Assuming that dimensions of input data of the spatiotemporal attention component 40e are

B×S×C×H×W, the input data with the dimensions of B×S×C×H×W (in which case the input data may be output of a previous spatiotemporal residual component) may be reshaped into data with dimensions of (B×S)×C×(H×W), and the data with the dimensions of (B×S)×C×(H×W) is inputted into the spatial attention sub-component of the spatiotemporal attention component 40e. Output of the spatial attention sub-component in the spatiotemporal attention component 40e may be reshaped into data with dimensions of (B×H×W)×C×S, and the data with the dimensions of (B×H×W)×C×S is inputted into the temporal attention sub-component of the spatiotemporal attention component 40e. Finally, dimensions of the output of the spatiotemporal attention component 40e are converted to B×S×C×H×W.

Each spatiotemporal attention component in the initial generation model 40a may be a transformer block (a transformer module, where a transformer is a model that uses an attention mechanism to increase a model training speed). The spatial attention sub-component in each spatiotemporal attention component may be a spatial transformer block, and the temporal attention sub-component may be a temporal transformer block. In some embodiments, a network structure of the spatiotemporal attention component in the initial generation model 40a is not limited to the foregoing transformer block, or may be a conformer module (a transformer module based on convolution enhancement) or the like, which is not limited in present disclosure.

Operation S105: Perform, in the M spatiotemporal residual components and the M spatiotemporal attention components, noise prediction on the video input data according to the sample text encoding feature and the first embedding information to obtain sample predicted noise.

After the video input data, the sample text encoding feature, and the first embedding information are inputted into the initial generation model, a data processing process of the video input data, the sample text encoding feature, and the first embedding information in the initial generation model may be referred to as a noise prediction process. For example, the spatiotemporal residual components in the initial generation model may have the same structure, and the spatiotemporal attention components may also have the same structure. For example, processing operations of the M spatiotemporal residual components in the initial generation model on respective input data may be considered similar, and processing operations of the M spatiotemporal attention components on respective input data may also be considered similar. For ease of understanding, an i^{th} spatiotemporal residual component and an i^{th} attention component in the initial generation model are used as examples for description below.

In one or more embodiments, feature extraction may be performed, by using an i^{th} spatiotemporal residual component of the M spatiotemporal residual components, on the first embedding information and input data of the i^{th} spatiotemporal residual component, to obtain a sample residual feature of the i^{th} spatiotemporal residual component. i is a positive integer less than or equal to M. Attention processing is performed on the sample text encoding feature and the sample residual feature of the i^{th} spatiotemporal residual component by using an i^{th} spatiotemporal attention component of the M spatiotemporal attention components, to obtain a sample attention feature of the i^{th} spatiotemporal attention component. A sample attention feature of the last spatiotemporal attention component (which may be referred to as an M^{th} spatiotemporal attention component) of the M spatiotemporal attention components is determined as the sample predicted noise. When i is 1, the input data of the i^{th} spatiotemporal residual component includes the video input data and the first embedding information. When i is not 1, the input data of the i^{th} spatiotemporal residual component includes the first embedding information and a sample attention feature of an (i−1)^{th} spatiotemporal attention component.

The i^{th} spatiotemporal residual component in the initial generation model includes a spatial convolutional layer and a temporal convolutional layer. When i is 1, input data of the i^{th} spatiotemporal residual component includes the video input data and the first embedding information, for example, the spatiotemporal residual component 40b shown in FIG. 5. When i is greater than 1 and is less than or equal to M/2+1, the input data of the i^{th} spatiotemporal residual component includes an output feature of the (i−1)^{th} spatiotemporal attention component (which may be referred to as a sample attention feature) and the first embedding information, for example, the spatiotemporal residual component 40d, the spatiotemporal residual component 40f, and the spatiotemporal residual component 40h shown in FIG. 5. When i is greater than M/2+1, the input data of the i^{th} spatiotemporal residual component includes the sample attention feature of the (i−1)^{th} spatiotemporal attention component, the first embedding information, and an output feature of a spatiotemporal residual component (which may be referred to as a sample residual feature) symmetrically positioned with respect to the i^{th} spatiotemporal residual component in the initial generation model, for example, the spatiotemporal residual component 40j, the spatiotemporal residual component 40m, and the spatiotemporal residual component 40p shown in FIG. 5. Input data of the spatiotemporal residual component 40j includes the sample attention feature of the spatiotemporal attention component 40i, the first embedding information, and the sample residual feature of the spatiotemporal residual component 40f.

For the i^{th} spatiotemporal residual component in the initial generation model (the i^{th} spatiotemporal residual component herein may be any spatiotemporal residual component in the initial generation model), the first embedding information and the input data of the i^{th} spatiotemporal residual component may be added to obtain a combined input feature. Dimensions of the combined input feature may be reshaped from B×S×C×H×W to (B×S)×C×H×W. By using the spatial convolutional layer in the i^{th} spatiotemporal residual component, spatial convolution operation is performed on the combined input feature with the dimensions of (B×S)×C×H×W to obtain a spatial convolution feature, and dimension transformation is performed on the spatial convolution feature with the dimensions of (B×S)×C×H×W to obtain a convolution transformed feature with dimensions of (B×H×W)×C×S. By using the temporal convolutional layer in the i^{th} spatiotemporal residual component, temporal convolution operation is performed on the convolution transformed feature with the dimensions of (B×H×W)×C×S to obtain a temporal convolution feature. Dimensions of the temporal convolution feature may be transformed from (B×H×W)×C×S to B×S×C×H×W. The sample residual feature of the i^{th} spatiotemporal residual component is obtained according to the temporal convolution feature with the dimensions of B×S×C×H×W and the input data of the i^{th} spatiotemporal residual component. Dimensions of the sample residual feature of the i^{th} spatiotemporal residual component are B×S×C×H×W. In some embodiments, in addition to the spatial convolutional layer and the temporal convolutional layer, the i^{th} spatiotemporal residual component may further include other network layers such as an activation network layer, a fully connected layer, and a pooling layer. A network structure of the spatiotemporal residual component is not limited in this embodiment of present disclosure.

The i^{th} spatiotemporal attention component in the initial generation model may include a spatial attention sub-component and a temporal attention sub-component. The sample text encoding feature corresponding to the sample description text may be inputted into a spatial attention sub-component in each spatiotemporal attention component. The sample residual feature of the i^{th} spatiotemporal residual component may be inputted into the spatial attention sub-component in the i^{th} spatiotemporal attention component. Dimensions of data inputted into the spatial attention sub-component need to be converted to (B×S)×C×(H×W). By using the spatial attention sub-component in the i^{th} spatiotemporal attention component, spatial attention processing is performed on the sample text encoding feature with the dimensions of (B×S)×C×(H×W) and the sample residual feature outputted by the i^{th} spatiotemporal residual component with the dimensions of (B×S)×C×(H×W) to obtain a spatial attention feature. Further, dimension transformation may be performed on the spatial attention feature to obtain an attention transformed feature. Dimensions of the attention transformed feature may be denoted as (B×H×W)×C×S. By using the temporal attention sub-component in the i^{th} spatiotemporal attention component, temporal attention processing is performed on the attention transformed feature to obtain the sample attention feature of the i^{th} spatiotemporal attention component. Dimensions of the sample attention feature need to be converted to B×S×C×H×W.

Attention processing involved in this embodiment of present disclosure may refer to a forward calculation process performed by each spatiotemporal attention component (an attention mechanism introduced in the initial generation model) in the initial generation model (or the trained video generation model) on respective input data. The attention processing may include spatial attention processing and temporal attention processing. The spatial attention processing may refer to a forward calculation process performed by the spatial attention sub-component (which may include a spatial self-attention layer, a spatial cross-attention layer, a feedforward network layer, and the like) in each spatiotemporal attention component on respective input data. The temporal attention processing may refer to forward calculation performed by the temporal attention sub-component (which may include one or more temporal self-attention layers, a feedforward network layer, and the like) in each spatiotemporal attention component on respective input data. Input data of the spatial attention processing is different from that of the temporal attention processing, dimensions of the input data supported are also different, and processing processes of the input data also differ. The spatial attention processing may be configured for capturing spatial information in a sample video under a text condition, and the temporal attention processing may be configured for capturing temporal information in the sample video. Specific implementation processes of the spatial attention processing and the temporal attention processing are to be described in subsequent content.

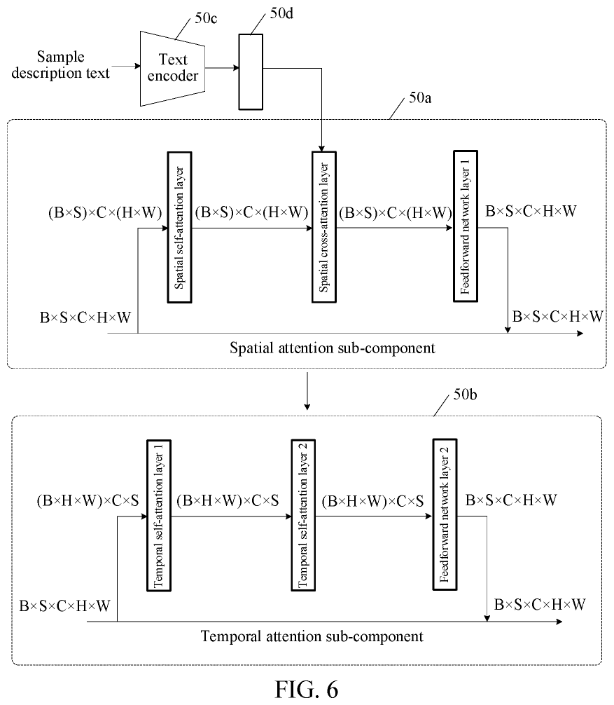

Structures of the spatial attention sub-component and the temporal attention sub-component in the i^{th} spatiotemporal attention component may be seen in FIG. 6. FIG. 6 is a schematic structural diagram of a spatiotemporal attention component in an initial generation model according to some embodiments of present disclosure. The spatial attention sub-component in the i^{th} spatiotemporal attention component may be shown as a spatial attention sub-component 50a in FIG. 6. The spatial attention sub-component 50a may include, but is not limited to, a spatial self-attention layer, a spatial cross-attention layer, a feedforward network layer 1, and the like. Dimensions of input data of the spatial self-attention layer, the spatial cross-attention layer, and the feedforward network layer are all (B×S)×C×(H×W). The temporal attention sub-component in the i^{th} spatiotemporal attention component may be shown as a temporal attention sub-component 50b in FIG. 6. The temporal attention sub-component 50b may include, but is not limited to, a temporal self-attention layer 1, a temporal self-attention layer 2, a feedforward network layer 2, and the like. Dimensions of input data of the temporal self-attention layer 1, the temporal self-attention layer 2, and the feedforward network layer 2 are all (B×H×W)×C×S.

In one or more embodiments, an implementation process of performing spatial attention processing on the sample text encoding feature and the sample residual feature of the i^{th} spatiotemporal residual component by using the spatial attention sub-component (for example, the spatial attention sub-component 50a) in the i^{th} spatiotemporal attention component, to obtain a spatial attention feature may include: after text encoding processing is performed, by using the text encoder 50c, on the sample description text to obtain a sample text encoding feature 50d, inputting the sample text encoding feature 50d and the sample residual feature of the i^{th} spatiotemporal residual component to the spatial attention sub-component 50a in the i^{th} spatiotemporal attention component; and transforming the sample residual feature of the i^{th} spatiotemporal residual component into a spatial query matrix (which may be denoted as Q1), a spatial key matrix (which may be denoted as K1), and a spatial value matrix (which may be denoted as V1) according to a transformation weight matrix corresponding to the spatial self-attention layer in the spatial attention sub-component 50a. The transformation weight matrix corresponding to the spatial self-attention layer may include three parameter matrices, such as a parameter matrix W_{q}, a parameter matrix Wₖ, and a parameter matrix Wᵥ. A transformation weight corresponding to the spatial self-attention layer may be learned during the training. The spatial query matrix Q1 may be obtained by performing a dot product between the sample residual feature of the i^{th} spatiotemporal residual component and the parameter matrix W_{q} in the transformation weight matrix. The spatial key matrix K1 may be obtained by performing a dot product between the sample residual feature of the i^{th} spatiotemporal residual component and the parameter matrix Wₖ in the transformation weight matrix. The spatial value matrix V1 may be obtained by performing a dot product between the sample residual feature of the i^{th} spatiotemporal residual component and the parameter matrix Wᵥ in the transformation weight matrix. Each query vector in the foregoing spatial query matrix may be configured for encoding a similarity relationship between each feature and another feature. The similarity relationship may determine dependency information between the feature and a preceding feature.

A dot product operation may be performed on the spatial query matrix Q1 and a transposed matrix of the spatial key matrix K1 to obtain a first candidate weight matrix (which may be denoted as

$${Q}_{1} {K}_{1}^{T} ) .$$

The first candidate weight matrix may be an inner product (which may also be referred to as a dot product) of each row of vectors in the spatial query matrix Q1 and the spatial key matrix K1. To prevent an excessively large inner product, a first column quantity corresponding to the spatial query matrix Q1 may be acquired (the spatial query matrix Q1 and the spatial key matrix K1 have the same column quantity, which may also be referred to as a vector dimension). A ratio between the first candidate weight matrix and a square root of the first column quantity (which may be denoted as \sqrt{d1}) is normalized to obtain a first attention weight matrix. A spatial self-attention feature is obtained according to a dot product between the first attention weight matrix and the spatial value matrix V1. The first attention weight matrix may be represented as softmax

$$( \frac{{Q}_{1} {K}_{1}^{T}}{\sqrt{d 1}} ) .$$

A softmax function is a function configured for normalization processing. The softmax function may be configured for calculating a self-attention coefficient of a single feature with respect to another feature. softmax may be performed on each row in

$$\frac{{Q}_{1} {K}_{1}^{T}}{\sqrt{d 1}}$$

by using the softmax function. A dot product between the first attention weight matrix and the space value matrix V1 is determined as an output feature of the spatial self-attention layer (which may be represented as

$${O}_{1} = soft max ( \frac{{Q}_{1} {K}_{1}^{T}}{\sqrt{d 1}} ) {V}_{1} ) .$$

In this case, the output feature of the spatial self-attention layer may be used as the spatial self-attention feature.

Further, the sample text encoding feature 50d corresponding to the foregoing sample description text may be inputted into the spatial cross-attention layer in the spatial attention sub-component 50a. An attention operation is performed on the foregoing spatial self-attention feature (the output feature of the spatial self-attention layer) and the sample text encoding feature 50d by using the spatial cross-attention layer in the spatial attention sub-component 50a, to guide noise prediction of the 3D U-net to obtain a spatial cross-attention feature. The attention operation herein may be performing a data processing process similar to that of the foregoing spatial self-attention layer on a feature formed by the spatial self-attention feature and the sample text encoding feature 50d. Details are not described herein again. By using the feedforward network layer (such as the feedforward network layer 1 in the spatial attention sub-component 50a in FIG. 6) in the spatial attention sub-component, feature transformation is performed on the spatial cross-attention feature to obtain the spatial attention feature. For example, a hidden weight matrix and a bias vector that correspond to the feedforward network layer 1 in the spatial attention sub-component 50a may be acquired. The spatial attention feature is determined based on the bias vector and a dot product between the hidden weight matrix and the spatial attention feature.

In one or more embodiments, a process of performing, by using the temporal attention sub-component (e.g., the temporal attention sub-component 50b shown in FIG. 6) in the i^{th} spatiotemporal attention component, temporal attention processing on the attention transformed feature to obtain a sample attention feature of the i^{th} spatiotemporal attention component may include: transforming the attention transformation matrix into a temporal query matrix (which may be denoted as Q2), a temporal key matrix (which may be denoted as K2), and a temporal value matrix (which may be denoted as V2) according to a transformation weight matrix corresponding to the temporal self-attention layer (e.g., the temporal self-attention layer 1 shown in FIG. 6) in the temporal attention sub-component 50b. A dot product operation is performed on the temporal query matrix Q2 and a transposed matrix of the temporal key matrix K2 to obtain a second candidate weight matrix (which may be denoted as

$${Q}_{2} {K}_{2}^{T} ) ,$$

and a second column quantity corresponding to the temporal query matrix Q2 is acquired. A ratio between the second candidate weight matrix and a square root of the second column quantity (which may be denoted as \sqrt{d2}) is normalized to obtain a second attention weight matrix (which may be denoted as softmax

$$( \frac{{Q}_{2} {K}_{2}^{T}}{\sqrt{d 2}} ) ) .$$

A temporal self-attention feature is obtained according to a dot product between the second attention weight matrix and the temporal value matrix V2. By using the feedforward network layer in the temporal attention sub-component, feature transformation is performed on the temporal self-attention feature to obtain the sample attention feature of the i^{th} spatiotemporal attention component. As shown in FIG. 6, the temporal attention sub-component may include two temporal self-attention layers (a temporal self-attention layer 1 and a temporal self-attention layer 2). Processing processes of the two temporal self-attention layers on input data are the same. The processing processes thereof may be obtained with reference to the foregoing data processing process of the spatial self-attention layer. Details are not described herein again.

Similar to the foregoing data processing process in the i^{th} spatiotemporal residual component and the i^{th} spatiotemporal attention component, data processing may be performed on the input data (which may include the video input data, the first embedding information, and the sample text encoding feature) by using the M spatiotemporal residual components and the M spatiotemporal attention components of the initial generation model, to obtain the sample predicted noise corresponding to the video input data. For example, the sample attention feature of the last spatiotemporal attention component in the initial generation model may be used as sample predicted noise outputted by the initial generation model for the video input data.

Operation S106: Correct a network parameter of the initial generation model according to the sample original noise and the sample predicted noise, and determine the initial generation model including the corrected network parameter as a video generation model; the video generation model being configured to generate video data matching a video description text.

For example, a mean squared error (MSE) loss between the sample original noise and the sample predicted noise may be acquired. Iterative training is performed on the network parameter of the initial generation model according to the mean square error loss, training is stopped until the initial generation model meets a training ending condition, and the initial generation model at the end of training is determined as the video generation model. The MSE loss may be shown in Formula (2):

L(θ)= [symbol] ₓ_{₀}_{,c,ϵ}∥ϵ−f_{θ}(xₜ₁,t1,c1)∥² (2)

In Formula (2), L(θ) represents an MSE loss corresponding to the initial generation model, θ represents a trainable parameter (a network parameter) in the initial generation model, f_{θ}(x+1, t1, c1) represents sample predicted noise outputted by the initial generation model, f_{θ} represents the 3D U-Net model (which may be referred to as a conditional model) in the initial generation model, xₜ₁ represents the video input data, t1 represents the first step quantity encoding feature, and c1 represents the sample text encoding feature.

The foregoing training ending condition may include, but is not limited to, a preset maximum quantity of times of iteration, a value of a total loss of the model being less than or equal to a preset error value, and the like, which is not limited in present disclosure. When the initial generation model meets the training ending condition, training may be stopped, a current network parameter is saved, and the initial generation model including the current network parameter is determined as the video generation model. The video generation model is a trained initial generation model, and may be configured to generate target video data conforming to text content from arbitrary Gaussian noise in combination with the video description text.

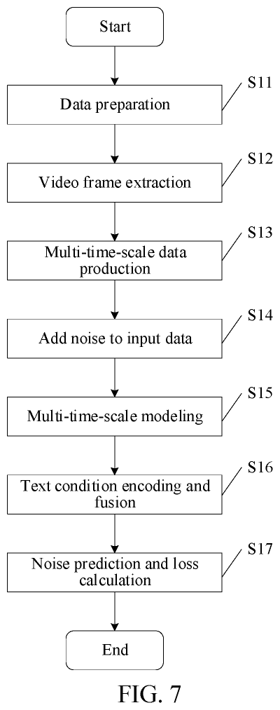

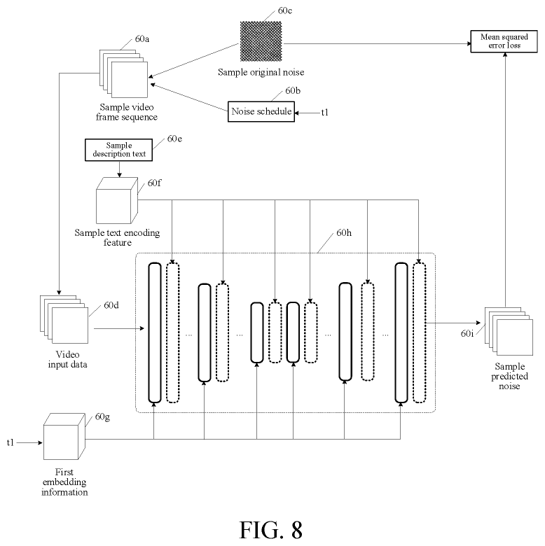

Referring to FIG. 7, FIG. 7 is a schematic flowchart of a training phase of an initial generation model according to some embodiments of present disclosure. In some embodiments, operations may be performed sequentially, in a different order, in parallel, or with some operations skipped or repeated. As shown in FIG. 7, the training phase of the initial generation model may include the following operation S11 to operation S17:
S11: Data preparation.

For example, a batch of videos and corresponding video text descriptions may be collected to form (video, text) pairs, for training the initial generation model. The (video, text) pairs herein may be used as sample pairs for training the initial generation model, and one (video, text) pair includes a video and a video description text corresponding thereto. In this embodiment of present disclosure, the video in the (video, text) pair may be referred to as a sample video, and the text (e.g., the video description text) in the (video, text) pair may be referred to as a sample description text.
S12: Video frame extraction.

For example, assuming that the initial generation model supports input of up to S (a preset video frame quantity threshold) video frames for training, fixed T video frames may be extracted from each video to form an initial video frame sequence tensor with dimensions of B×T×3×H×W.
S13: Multi-time-scale data production.

For example, when distributed training is performed on the initial generation model, at each training step, dimensions of initial input of the initial generation model on each GPU (rank) may be B×S₀×3×H×W. To implement multi-time-scale modeling, each rank may randomly extract sample video frame sequences having different quantities of video frames, which are denoted as x₀, with dimensions of B×S×3×H×W, S∈[1, S₀]. In this way, the initial generation model may perform multi-time-scale modeling based on videos of different durations.
S14: Add noise to input data.

For example, according to Formula (1) above, Gaussian noise & having the same dimensions as the sample video frame sequence is randomly generated according to the DDPM and the first step quantity t1. The Gaussian noise & in this case may be referred to as the sample original noise. According to the first step quantity and the sample original noise ε, data noise addition processing is performed on the sample video frame sequence to obtain video input data xₜ₁ (which may also be referred to as noisy input data). The video input data xₜ₁ may be calculated according to Formula (1).
S15: Multi-time-scale modeling.

For example, multi-time-scale temporal modeling may be based on a designed 3D U-Net model (which may be denoted as a conditional model f_{θ}). For example, a temporal convolutional layer (or may be referred to as a temporal convolutional module, which may be added after a spatial convolutional layer in a 2D U-Net model) and a temporal attention sub-component (which may be added after a spatial attention sub-component in the 2D U-Net model) may be added to the current 2D U-Net model. The two temporal modeling manners, e.g., the temporal convolutional layer and the temporal attention sub-component, support input of an arbitrary length, and thus are compatible with video input data having different quantities of video frames. For a network structure of the initial generation model obtained by multi-time-scale modeling, refer to the descriptions in some embodiments corresponding to FIG. 5 and FIG. 6. Details are not described herein again.
S16: Text condition encoding and fusion.

For example, the sample description text corresponding to the sample video is inputted into the text encoder. Assuming that a length of the sample description text is L(L is a positive integer), text encoding processing is performed on the sample description text by using the text encoder, and a sample text encoding feature (which may be denoted as c1) with dimensions of B×L×Dₜₑₓₜ may be obtained, where B represents a batch size, L represents the length of the sample description text, and Dₜₑₓₜ represents a vector dimension of a unit character. The sample text encoding feature c1 may be inputted into the spatial cross-attention layer included in each spatial attention sub-component in the initial generation model, and an attention operation is performed with original input (the spatial self-attention feature) of the spatial cross-attention layer to guide the noise prediction of the 3D U-Net model. In some embodiments, during the training, a drop operation may be randomly performed on the sample description text at a probability p (e.g., changed to an empty string), and at the same time, the initial generation model is trained to support unconditional generation without text. For example, in the training phase, the initial generation model may be trained to support both conditional generation with text and unconditional generation without text, which can broaden applicable scenarios of the initial generation model and improve accuracy of noise prediction of the initial generation model.
S17: Noise prediction and loss calculation.

For example, the video input data xₜ₁, the sample text encoding feature c1 (the text condition), and the first embedding information corresponding to the first step quantity t1 are inputted into the initial generation model (e.g., the foregoing designed 3D U-Net model), to perform prediction to obtain sample predicted noise f_{θ}(xₜ₁, t1, c1). According to the DDPM, the MSE loss between the sample original noise & and the sample predicted noise f_{θ}(xₜ₁, t1, c1) may be calculated (which may be calculated according to Formula (2) above). The entire initial generation model is trained using the MSE loss. The trained video generation model may generate target video data conforming to text content from arbitrary Gaussian noise in combination with the video description text.

Referring to FIG. 8, FIG. 8 is a schematic diagram of training of an initial generation model according to some embodiments of present disclosure. As shown in FIG. 8, by using operation S11 to operation S13 in the embodiment corresponding to FIG. 7, a sample video frame sequence 60a may be acquired from the sample video. In this case, the sample video frame sequence 60a may be used as initial input to an initial generation model 60h. A first step quantity t1 may be randomly sampled according to a preset diffusion parameter T_{S}. Diffusion rates corresponding to the first step quantity t1 and all step quantities less than the first step quantity t1 may be acquired from a set noise schedule 60b, thereby obtaining a sequence weight corresponding to the sample video frame sequence 60a. At the same time, Gaussian noise e may be randomly sampled from a standard normal distribution, and the Gaussian noise € is added as sample original noise 60c to the sample video frame sequence 60a. Data noise addition processing is performed on the sample video frame sequence 60a according to the sample original noise 60c, the sequence weight, and the original noise weight (which may be determined by the sequence weight) to obtain video input data 60d. The first step quantity t1 may be encoded into first embedding information 60g, and the first embedding information 60g may be inputted into each spatiotemporal residual component in the initial generation model 60h.

A sample description text 60e corresponding to the sample video may be inputted into the text encoder. Text encoding processing is performed on the sample description text 60e by using the text encoder, to obtain a sample text encoding feature 60f corresponding to the sample description text 60e. The sample text encoding feature 60f may be inputted into each spatiotemporal attention component in the initial generation model 60h, and may be inputted into a spatial cross-attention layer in each spatiotemporal attention component, to guide noise prediction of the initial generation model 60h. For example, after the video input data 60d, the first embedding information 60g, and the sample text encoding feature 60f are inputted into the initial generation model 60h, the sample predicted noise 60i may be outputted by using the initial generation model 60h. An MSE loss between the sample original noise 60c and the sample predicted noise 60i is calculated, the initial generation model 60h is trained by using the MSE loss, and the trained initial generation model 60h may be referred to as the video generation model.

In this embodiment of present disclosure, during the training of the initial generation model, the initial generation model is trained by using sample video frame sequences having different frame quantities. By using the spatiotemporal residual components and the spatiotemporal attention components in the initial generation model, the initial generation model can efficiently capture long-term and short-term temporal action information during the training, e.g., learn temporal action information in videos of different time scales, which improves comprehensiveness of the temporal action information, thereby enhancing quality of video generation.

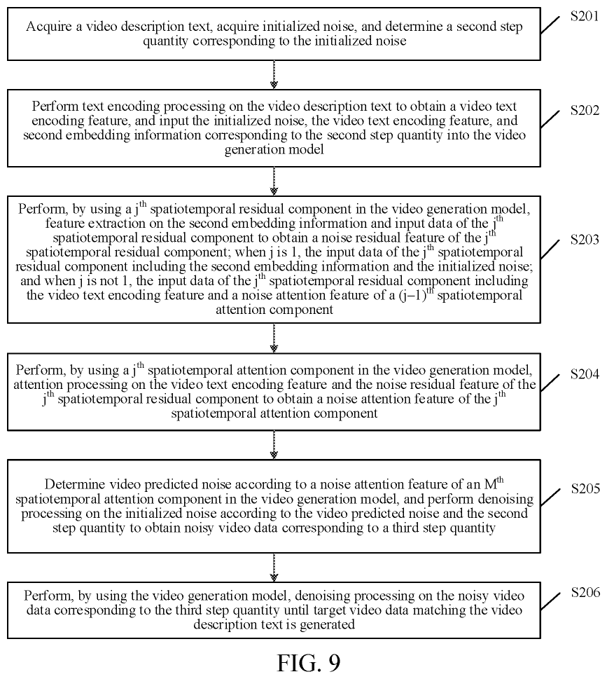

Referring to FIG. 9, FIG. 9 is a schematic flowchart II of a video generation method according to some embodiments of present disclosure. The video generation method may be performed by a computer device. The computer device may be a server or may be a terminal device, which is not limited in present disclosure. In some embodiments, operations may be performed sequentially, in a different order, in parallel, or with some operations skipped or repeated As shown in FIG. 9, the video generation method may include the following operation S201 to operation S206:

Operation S201: Acquire a video description text, acquire initialized noise, and determine a second step quantity corresponding to the initialized noise.

For example, the trained video generation model may be configured to generate target video data with different durations. A process of generating the target video data by using the video generation model may be referred to as a sampling phase. A data processing process in the sampling phase may include: first acquiring a video description text configured for generating video data, where the video description text may be inputted into the video generation model as a text condition, to guide the video generation model to generate target video data conforming to the video description text; and then randomly initializing Gaussian noise for the video generation model, where the Gaussian noise may be referred to as initialized noise. Dimensions of the initialized noise may be represented as B′×S″×3×H×W, S″∈[1, S], where B′, S″, H, and W respectively represent a quantity of videos to be generated, a quantity of duration frames (e.g., a quantity of video frames to be generated), a height of a generated video, and a width of the generated video. A step quantity corresponding to the foregoing initialized noise may be referred to as a second step quantity (for ease of understanding, the second step quantity may be denoted as t2, and the initialized noise may be denoted as zₜ₂). The second step quantity t2 may be configured for representing a degree of noise addition of the initialized noise zₜ₂, the second step quantity t2 may be any integer value in a range of [1, T_{S}], and T_{S} is a preset diffusion parameter.

Since a multi-time-scale modeling manner is adopted in the training phase, e.g., the video generation model is trained using sample video frame sequences having different quantities of video frames, during video generation, generation of videos of any length within a range of [1, S₀] is supported. For example, the video generation model may generate target video data of different durations.

Operation S202: Perform text encoding processing on the video description text to obtain a video text encoding feature, and input the initialized noise, the video text encoding feature, and second embedding information corresponding to the second step quantity into the video generation model.

For example, the video description text may be inputted into a pre-trained text encoder, and text encoding processing is performed on the video description text by using the text encoder, to obtain the video text encoding feature corresponding to the video description text. For a text encoding process of the video description text, refer to the description of the text encoding process of the sample description text in operation S102 in the embodiment corresponding to FIG. 3. Details are not described herein again.

Vector representation may be performed on the second step quantity t2. For example, one-hot encoding may be used for vector representation of the second step quantity, or another encoding manner may be used for vector representation of the second step quantity, which is not limited in present disclosure. Further, encoding processing may be performed on the vector representation of the second step quantity t2 to obtain second embedding information corresponding to the second step quantity t2.

The initialized noise zₜ₂, the second embedding information, and the video text encoding feature may be inputted into the trained video generation model. The initialized noise zₜ₂ may be inputted into the first spatiotemporal residual component in the video generation model. The second embedding information may be inputted into each spatiotemporal residual component of the video generation model. The video text encoding feature may be inputted into the spatial cross-attention layer of each spatiotemporal attention component in the video generation model. A network structure of the video generation model is the same as that of the foregoing initial generation model. For details, refer to some embodiments corresponding to FIG. 5 and FIG. 6. Details are not described herein again.

Operation S203: Perform, by using a j^{th} spatiotemporal residual component in the video generation model, feature extraction on the second embedding information and input data of the j^{th} spatiotemporal residual component to obtain a noise residual feature of the j^{th} spatiotemporal residual component; when j is 1, the input data of the j^{th} spatiotemporal residual component including the second embedding information and the initialized noise; and when j is not 1, the input data of the j^{th} spatiotemporal residual component including the video text encoding feature and a noise attention feature of a (j−1)^{th} spatiotemporal attention component.

Operation S204: Perform, by using a j^{th} spatiotemporal attention component in the video generation model, attention processing on the video text encoding feature and the noise residual feature of the j^{th} spatiotemporal residual component to obtain a noise attention feature of the j^{th} spatiotemporal attention component.

For example, the video generation model may include M spatiotemporal residual components and M spatiotemporal attention components that are connected in an alternating manner. The M spatiotemporal residual components in the video generation model may perform the same operation on respective input data thereof. Similarly, the M spatiotemporal attention components in the video generation model may perform the same operation on respective input data thereof. For ease of understanding, in this embodiment of present disclosure, the j^{th} spatiotemporal residual component and the j^{th} spatiotemporal attention component that are connected to each other in the video generation model are used as examples for description, where j is a positive integer less than or equal to M. For example, the j^{th} spatiotemporal residual component may be any spatiotemporal residual component in the video generation model, and the j^{th} spatiotemporal attention component may be any spatiotemporal attention component in the video generation model.

The j^{th} spatiotemporal residual component in the video generation model may include a spatial convolutional layer and a temporal convolutional layer. When j is 1, the input data of the j^{th} spatiotemporal residual component includes the initialized noise zₜ₂ and the second embedding information. When j is greater than 1 and is less than or equal to M/2+1, the input data of the j^{th} spatiotemporal residual component may include an output feature of the (j−1)^{th} spatiotemporal attention component (which may be referred to as a noise attention feature) and the second embedding information. When j is greater than M/2+1, the input data of the j^{th} spatiotemporal residual component may include the noise attention feature of the (j−1)^{th} spatiotemporal attention component, the second embedding information, and an output feature of a spatiotemporal residual component (which may be referred to as a noise residual feature) symmetrically positioned with respect to the j^{th} spatiotemporal residual component in the video generation model. The j^{th} spatiotemporal attention component in the video generation model may include a spatial attention sub-component and a temporal attention sub-component. The spatial attention sub-component may include a spatial self-attention layer, a spatial cross-attention layer, and a feedforward network layer. The temporal attention sub-component may include one or more temporal self-attention layers (for example, may include two temporal self-attention layers) and one feedforward network layer. The input data of the j^{th} spatiotemporal attention component is an output feature of the j^{th} spatiotemporal residual component (a noise residual feature). For a processing process of the initialized noise zₜ₂, the second embedding information, and the video text encoding feature in the video generation model, refer to related descriptions in operation S105 in the embodiment corresponding to FIG. 3. Details are not described herein again.

In the sampling phase, after the initialized noise zₜ₂, the second embedding information, and the video text encoding feature are inputted into the video generation model, N-step denoising may be performed according to a sampling manner such as a denoising diffusion implicit model (DDIM) or DDPM, finally obtaining noise-free target video data conforming to semantics of the video description text. Dimensions of the target video data may be represented as 3×H×W. N is a positive integer. For example, N may be any value less than or equal to T_{S} (the diffusion parameter). N may be set according to an actual requirement. A sampling manner and the value of N are not limited in this embodiment of present disclosure.

During the training of the initial generation model, a drop operation is randomly performed on the sample text encoding feature corresponding to the sample description text at a probability p (changing the sample description text to an empty string, which may be understood as zeroing the sample text encoding feature to become a zero matrix), so that the trained video generation model supports both conditional generation with text and unconditional generation without text. Therefore, a classifier-free guidance technology may be adopted in the sampling phase. At each denoising step, two types of noise may be predicted simultaneously: one is predicted noise under a text condition (which may be referred to simply as conditional predicted noise), and the other is predicted noise under a non-text condition (which may be referred to simply as unconditional predicted noise). The conditional predicted noise may mean using the video text encoding feature corresponding to the video description text as a text condition to guide the noise prediction of the 3D U-Net in the process of using the 3D U-Net in the video generation model for noise prediction. Simultaneously may refer to two or more events, actions, or processes occurring at the same time, substantially at the same time, or within a sufficiently short time interval such that the events are perceived or functionally treated as occurring together. The unconditional predicted noise may refer to predicted noise obtained after the video description text is changed to an empty string (e.g., the video text encoding feature is changed to a zero matrix) in the process of using the 3D U-Net in the video generation model for noise prediction.

Operation S205: Determine video predicted noise according to a noise attention feature of an M^{th} spatiotemporal attention component in the video generation model, and perform denoising processing on the initialized noise according to the video predicted noise and the second step quantity to obtain noisy video data corresponding to a third step quantity; the third step quantity being less than the second step quantity.

Operation S206: Perform, by using the video generation model, denoising processing on the noisy video data corresponding to the third step quantity until target video data matching the video description text is generated.

For example, the video predicted noise predicted by the 3D U-Net may be obtained according to an output result of the 3D U-Net in the video generation model. The output result of the 3D U-Net may be an output feature (a noise attention feature) of the last spatiotemporal attention component (e.g., the M^{th} spatiotemporal attention component) in the 3D U-Net. When the video generation model uses only conditional generation with text (which may be referred to simply as a conditional model), the noise attention feature of the M^{th} spatiotemporal attention component in the video generation model may be considered as noise prediction obtained under guidance of the video text encoding feature. In this case, the noise attention feature of the M^{th} spatiotemporal attention component in the video generation model may be determined as the video predicted noise.

In some embodiments, if the video generation model uses both conditional generation with text (a conditional model) and unconditional generation without text (which may be referred to simply as an unconditional model), the classifier-free guidance technology may be adopted in the sampling phase. Then, when noise prediction is performed by using the 3D U-Net in the video generation model, the noise attention feature of the M^{th} spatiotemporal attention component in the video generation model may include a noise attention feature under a text condition and a noise attention feature under a non-text condition. The noise attention feature under the text condition refers to an attention feature obtained using the video text encoding feature, or may refer to an attention feature obtained when the video text encoding feature is used as the text condition. The noise attention feature under the non-text condition refers to an attention feature obtained using a zeroed video text encoding feature, or may refer to an attention feature obtained when the video text encoding feature is changed to a zero matrix, e.g., when there is no text condition.

The conditional predicted noise may be generated according to the noise attention feature under the text condition, and the unconditional predicted noise may be generated according to the noise attention feature under the non-text condition. For example, the noise attention feature under the text condition may be used as the conditional predicted noise, and the noise attention feature under the non-text condition may be used as the unconditional predicted noise. Furthermore, a noise difference between the conditional predicted noise and the unconditional predicted noise may be acquired. The video predicted noise is obtained by summing the unconditional predicted noise and a product of a noise intensity parameter and the noise difference. The video predicted noise in this case may be video predicted noise corresponding to the second step quantity predicted by the video generation model. For example, the video predicted noise may be obtained by fusing the conditional predicted noise and the unconditional predicted noise. Denoising using the video predicted noise can improve quality of video generation. The video predicted noise may be shown in Formula (3):

[symbol]

=ϵ_{ø}+ω(ϵ_{σ}−ϵ_{ø}) (3)

In Formula (3), [symbol] represents video predicted noise corresponding to the second step quantity when the classifier-free guidance technology is adopted in the sampling phase; ϵ_{ø}=f_{ø}(zₜ₂, t2, ø) represents the unconditional predicted noise, and Ø represents that the video generation model uses a zeroed video text encoding feature when generating the unconditional predicted noise; ϵ_{θ}=f_{θ}(zₜ₂, t2, c2) represents the conditional predicted noise, zₜ₂ represents initialized noise inputted into the 3D U-Net in the video generation model, t2 represents the second step quantity, and c2 represents the video text encoding feature corresponding to the video description text; ω represents the noise intensity parameter, which is a guidance scale controlling noise intensity and is configured for controlling a direction of a generation effect between the unconditional model and the conditional model.

After the video predicted noise corresponding to the second step quantity is obtained, the noisy video data corresponding to the third step quantity may be calculated according to the video predicted noise, the initialized noise, and the second step quantity. The noisy video data corresponding to the third step quantity, third embedding information corresponding to the third step quantity, and the video text encoding feature may be inputted into the video generation model. The foregoing denoising process is repeated by using the video generation model until noise-free video data z₀ is obtained. The video data z₀ in this case may be used as target video data conforming to content of the video description text.

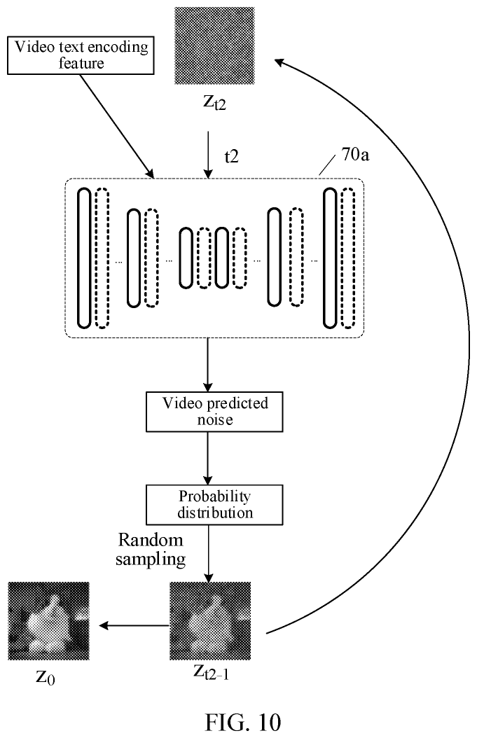

Referring to FIG. 10, FIG. 10 is a schematic diagram of sampling of a video generation model according to some embodiments of present disclosure. In this embodiment of present disclosure, a sampling process of the video generation model is described by using a DDPM manner as an example. As shown in FIG. 10, Gaussian noise may be randomly initialized for a video generation model 70a. The Gaussian noise may be used as initialized noise zₜ₂. In this case, a step quantity t2 corresponding to the initialized noise zₜ₂ may be referred to as a second step quantity. The initialized noise zₜ₂, step quantity encoding information (second embedding information) corresponding to the step quantity t2, and the video text encoding feature may be inputted into the video generation model 70a. Video predicted noise corresponding to the step quantity t2 may be obtained by using the video generation model 70a. For a noise prediction process of the video generation model 70a, refer to related descriptions in operation S203 to operation S205. Details are not described herein again.

A probability distribution corresponding to a step quantity t2−1 (in which case t2−1 may be used as the third step quantity) may be obtained according to the video predicted noise corresponding to the step quantity t2, and the probability distribution corresponding to the step quantity t2−1 may be denoted as p (zₜ₂₋₁|zₜ₂, z₀), conforming to

$$p ( {z}_{t 2 - 1} \vert {z}_{t 2} , {z}_{0} ) \sim N ( \frac{\sqrt{{β}_{t 2}} ( 1 - {α}_{t 2 - 1}^{2} )}{1 - {α}_{t 2}^{2}} {z}_{t 2} + \frac{{α}_{t 2 - 1} ( 1 - {β}_{t 2} )}{1 - {α}_{t 2}^{2}} {z}_{0} , {( \frac{\sqrt{1 - {β}_{t 2}} \sqrt{( 1 - {α}_{t 2 - 1}^{2} )}}{\sqrt{1 - {α}_{t 2}^{2}}} )}^{2} ) .$$

Noisy video data zₜ₂₋₁ corresponding to the step quantity t2−1 may be obtained by performing random sampling according to the probability distribution. The foregoing process may be referred to as single denoising processing performed using the video generation model, where zₜ₂₋₁ represents noisy video data corresponding to the step quantity t2−1, zₜ₂ represents initialized noise (which may be understood as the noisy video data corresponding to the step quantity t2), and z₀ represents noise-free video data (e.g., finally generated target video data); βₜ₂ represents a diffusion rate corresponding to the step quantity t2,

$${α}_{t 2 - 1} = \sqrt{{Π}_{t = 1}^{t 2 - 1} {β}_{t}} ,$$

e.g., a cumulative multiplication result of diffusion rates corresponding to all step quantities less than or equal to the step quantity t2−1; and

$${α}_{t2} = \sqrt{{Π}_{t = 1}^{t2} {β}_{t}} ,$$

e.g., a cumulative multiplication result of diffusion rates corresponding to all step quantities less than or equal to the step quantity t2. By using a reparameterization trick, the process of random sampling according to the above probability distribution may be converted to: randomly sampling Gaussian noise ϵ₀, and then calculating

$${z}_{t 2 - 1} = \frac{1}{\sqrt{{β}_{f 2}}} ( {z}_{t2} - \frac{1 - {β}_{f 2}}{\sqrt{1 - {a}_{f 2}^{2}}} ) \text{?} + {μ}_{t 2} {ϵ}_{0} ,$$

where [symbol] represents video predicted noise corresponding to the step quantity t2, and

$${μ}_{t 2}^{2} = \sqrt{( 1 - {β}_{t 2 - 1} ) / ( 1 - {β}_{t 2} )} \sqrt{( 1 - {β}_{t 2} / {β}_{t 2 - 1} )} .$$

For example, the noisy video data zₜ₂₋₁ corresponding to the step quantity t2−1 may be directly calculated by using the randomly sampled Gaussian noise ϵ₀, the video predicted noise [symbol] corresponding to the step quantity t2, the initialized noise zₜ₂, and the diffusion rates corresponding to all step quantities less than or equal to the step quantity t2. The noisy video data zₜ₂₋₁ corresponding to the step quantity t2−1 and the step quantity encoding information corresponding to the step quantity t2−1 may be inputted, together with the video text encoding feature, into the video generation model 70a as new input data, and the foregoing denoising processing is repeatedly performed until noise-free video data z₀ is generated. Further, the noise-free video data z₀ may be used as the finally generated target video data.

For example, it is assumed that when the second step quantity t2=1000, after denoising processing is performed once, noisy video data corresponding to the step quantity 999 (e.g., z₉₉₉) may be obtained. Denoising processing is continuously performed on the noisy video data z₉₉₉ by using the video generation model 70a, to obtain noisy video data corresponding to step number 998 z₉₉₈. The above operation is repeated until noise-free video data z₀ is obtained. For example, in the sampling phase, the noise-free video data z₀ can be obtained only by performing 1000 (the value of N is 1000)-step denoising processing by using the video generation model 70a. A step quantity (including the second step quantity, the third step quantity, and the like) in the sampling phase may be understood as a denoising step quantity. A step quantity in the training phase is to gradually add noise to the sample video frame sequence. A larger step quantity indicates higher intensity of noise added to the sample video frame sequence. The step quantity in the sampling phase is to perform stepwise denoising on the initialized noise. A smaller step quantity indicates more noise removed from the initialized noise. In this case, the step quantity may also be referred to as a denoising step quantity.

In some embodiments, if denoising is performed in a DDIM manner in the sampling phase, random noise (e.g., Gaussian noise ϵ₀ in the DDPM manner) does not need to be added to a process of generating the target video data (e.g., a denoising process). In this way, a generation process of video data may be accelerated by using a smaller sampling step quantity. For example, it is assumed that the diffusion parameter in the training phase is set to Tₛ=1000, a DDIM sampling manner is adopted in the sampling phase, and a sampling step quantity N is set to 50. Therefore, in the process of generating the target video data by using the trained video generation model, initialized noise corresponding to a step quantity 1000, embedding information corresponding to the step quantity 1000, and a video text encoding feature may be inputted into the video generation model, video predicted noise corresponding to the step quantity 1000 is outputted by using the 3D U-Net in the video generation model, and noisy video data corresponding to a step quantity 980 may be calculated according to a denoising formula corresponding to the DDIM (the denoising formula corresponding to the DDIM is the disclosure of the existing technology, and is not listed herein again). Further, the noisy video data corresponding to the step quantity 980, embedding information corresponding to the step quantity 980, and the video text encoding feature may be inputted into the video generation model, video predicted noise corresponding to a step quantity 960 is outputted by using the 3D U-Net in the video generation model, and noisy video data corresponding to the step quantity 960 may be calculated according to the denoising formula corresponding to the DDIM. The foregoing operation is repeated until the noise-free video data z₀ (the target video data conforming to the content of the video description text) is obtained. Compared with the DDPM sampling manner, in this embodiment of present disclosure, denoising processing is performed by using the DDIM sampling manner, which can increase a generation speed of the target video data.

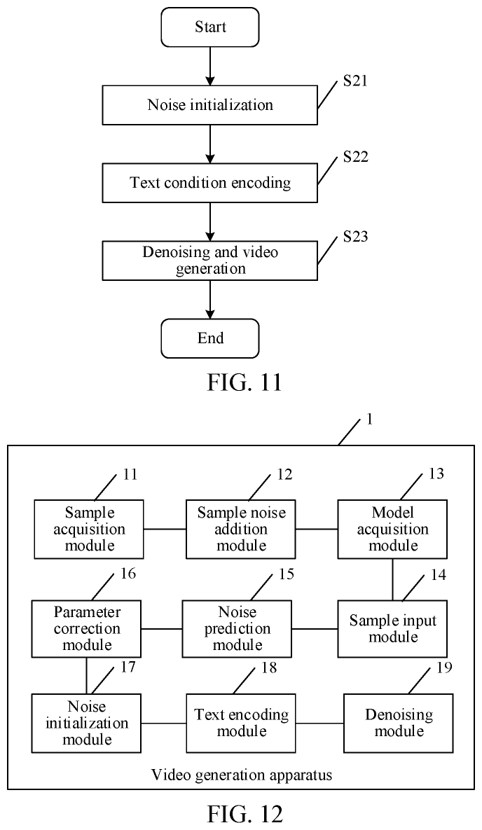

Referring to FIG. 11, FIG. 11 is a schematic flowchart of a sampling phase of a video generation model according to some embodiments of present disclosure. In some embodiments, operations may be performed sequentially, in a different order, in parallel, or with some operations skipped or repeated. As shown in FIG. 11, the sampling phase of the video generation model may include the following operation S21 to operation S23:
S21: Noise initialization.

For example, Gaussian noise may be randomly initialized, and the Gaussian noise may be used as initialized noise zₜ₂ inputted into the video generation model. Dimensions of the initialized noise zₜ₂ may be represented as B×S″×3×H×W, S″∈[1, S], and t2 herein may be referred to as a second step quantity.
S22: Text condition encoding.

For example, a video description text for creating a video may be acquired, the video description text is inputted into a text encoder, and text encoding processing is performed on the video description text by using the text encoder, to obtain a video text encoding feature corresponding to the video description text. The video text encoding feature may be referred to as text condition encoding.
S23: De-noising and video generation.

For example, the initialized noise zₜ₂, the video text encoding feature, and embedding information corresponding to the step quantity t2 are inputted into the video generation model, and N-step denoising is performed according to sampling manners such as DDPM and DDIM, to finally obtain noise-free target video data conforming to content of the video description text. For denoising and video generation processes, refer to related descriptions in the foregoing operation S203 to operation S206. Details are not described herein again.

In this embodiment of present disclosure, during the training of the initial generation model, the initial generation model is trained by using sample video frame sequences having different frame quantities. By using the spatiotemporal residual components and the spatiotemporal attention components in the initial generation model, the initial generation model can efficiently capture long-term and short-term temporal action information during the training, e.g., learn temporal action information in videos of different time scales, which improves comprehensiveness of the temporal action information, thereby enhancing quality of video generation. In the above training manner, videos of different durations may be generated in the sampling phase, and pictures have higher consistency and motion coherence at any duration, improving quality of video generation.

User information such as a human image of a user may be involved in a specific implementation of present disclosure. When the foregoing embodiments of present disclosure are applied to a specific product or technology, a license or consent of the user is to be obtained, and collection, use, and processing of the related data are to comply with related laws and regulations and standards of related regions.

Referring to FIG. 12, FIG. 12 is a schematic structural diagram of a video generation apparatus according to some embodiments of present disclosure. As shown in FIG. 12, the video generation apparatus 1 includes: a sample acquisition module 11, a sample noise addition module 12, a model acquisition module 13, a sample input module 14, a noise prediction module 15, and a parameter correction module 16.

The sample acquisition module 11 is configured to: acquire a sample video and a sample description text corresponding to the sample video, acquire a sample video frame sequence from the sample video, and determine a first step quantity and sample original noise for the sample video frame sequence.

The sample noise addition module 12 is configured to: perform data noise addition processing on the sample video frame sequence according to the first step quantity and the sample original noise to obtain video input data, and perform text encoding processing on the sample description text to obtain a sample text encoding feature.

The model acquisition module 13 is configured to acquire an initial generation model. The initial generation model includes M spatiotemporal residual components and M spatiotemporal attention components, and the M spatiotemporal residual components and the M spatiotemporal attention components in the initial generation model are alternately connected. M is an integer greater than 1.

The sample input module 14 is configured to: input the video input data into a first spatiotemporal residual component of the M spatiotemporal residual components, input first embedding information corresponding to the first step quantity into the M spatiotemporal residual components, and input the sample text encoding feature into the M spatiotemporal attention components.

The noise prediction module 15 is configured to perform, in the M spatiotemporal residual components and the M spatiotemporal attention components, noise prediction on the video input data according to the sample text encoding feature and the first embedding information to obtain sample predicted noise.

The parameter correction module 16 is configured to: correct a network parameter of the initial generation model according to the sample original noise and the sample predicted noise, and determine the initial generation model including the corrected network parameter as a video generation model. The video generation model is configured to generate video data matching a video description text.

In one or more embodiments, the sample acquisition module 11, when acquiring a sample video frame sequence from the sample video, is configured to perform the following operations:
determining a frame extraction interval duration corresponding to the sample video according to a video frame quantity threshold and a video duration corresponding to the sample video;
acquiring a plurality of video frames from the sample video according to the frame extraction interval duration, and combining the plurality of video frames into an initial video frame sequence; a quantity of video frames included in the initial video frame sequence being equal to the video frame quantity threshold; and
acquiring, from the initial video frame sequence, the sample video frame sequence for training the initial generation model; the sample video frame sequence being any subsequence, whose quantity of video frames is less than or equal to the video frame quantity threshold, of the initial video frame sequence.

In one or more embodiments, the sample acquisition module 11, when determining a first step quantity and sample original noise for the sample video frame sequence, is configured to perform the following operations:
acquiring a diffusion parameter corresponding to the initial generation model, and sampling the first step quantity corresponding to the sample video frame sequence according to the diffusion parameter; the diffusion parameter being configured for representing a total quantity of diffusion steps of the initial generation model, and the first step quantity being less than or equal to the diffusion parameter; and
generating Gaussian noise having the same dimensions as the sample video frame sequence, and determining the Gaussian noise as the sample original noise corresponding to the sample video frame sequence.

In one or more embodiments, the sample noise addition module 12, when performing data noise addition processing on the sample video frame sequence according to the first step quantity and the sample original noise to obtain video input data, is configured to perform the following operations:
determining a sequence weight corresponding to the sample video sequence according to the first step quantity, and determining an original noise weight corresponding to the sample original noise according to the sequence weight; a sum of squares of the sequence weight and the original noise weight being 1; and
adding a product of the sequence weight and the sample video sequence to a product of the original noise weight and the sample original noise to obtain the video input data.

In one or more embodiments, the sample noise addition module 12, when performing text encoding processing on the sample description text to obtain a sample text encoding feature, is configured to perform the following operations:
dividing the sample description text into D unit characters, and acquiring unit word vectors respectively corresponding to the D unit characters; D being a positive integer;
acquiring text vectors respectively corresponding to the D unit characters according to semantic information of the D unit characters in the sample description text;
acquiring position vectors respectively corresponding to the D unit characters according to text positions of the D unit characters in the sample description text;
combining the unit word vectors, the text vectors, and the position vectors to obtain an initial text feature corresponding to the sample description text; and
inputting the initial text features into a text encoder, and performing encoding processing on the initial text feature by using the text encoder, to obtain the sample text encoding feature corresponding to the sample description text.

In one or more embodiments, the noise prediction module 15, when performing, in the M spatiotemporal residual components and the M spatiotemporal attention components, noise prediction on the video input data according to the sample text encoding feature and the first embedding information to obtain sample predicted noise, is configured to perform the following operations:
performing, by using an i^{th} spatiotemporal residual component of the M spatiotemporal residual components, feature extraction on the first embedding information and input data of the i^{th} spatiotemporal residual component, to obtain a sample residual feature of the i^{th} spatiotemporal residual component; i being a positive integer less than or equal to M;
performing, by using an i^{th} spatiotemporal attention component of the M spatiotemporal attention components, attention processing on the sample text encoding feature and the sample residual feature of the i^{th} spatiotemporal residual component to obtain a sample attention feature of the i^{th} spatiotemporal attention component; and
determining a sample attention feature of the last spatiotemporal attention component of the M spatiotemporal attention components as the sample predicted noise;
where when i is 1, the input data of the i^{th} spatiotemporal residual component includes the video input data and the first embedding information; and when i is not 1, the input data of the i^{th} spatiotemporal residual component includes the first embedding information and a sample attention feature of an (i−1)^{th} spatiotemporal attention component.

In one or more embodiments, the i^{th} spatiotemporal residual component in the initial generation model includes a spatial convolutional layer and a temporal convolutional layer; and when i is greater than M/2+1, the input data of the i^{th} spatiotemporal residual component further includes a sample residual feature of a spatiotemporal residual component symmetrically positioned with respect to the i^{th} spatiotemporal residual component in the initial generation model; and
the noise prediction module 15, when performing, by using an i^{th} spatiotemporal residual component of the M spatiotemporal residual components, feature extraction on the first embedding information and input data of the i^{th} spatiotemporal residual component, to obtain a sample residual feature of the i^{th} spatiotemporal residual component, is configured to perform the following operations:
adding the first embedding information and the input data of the i^{th} spatiotemporal residual component to obtain a combined input feature;
performing, by using the spatial convolutional layer in the i^{th} spatiotemporal residual component, a spatial convolution operation on the combined input features to obtain a spatial convolution feature, and performing dimension transformation on the spatial convolution feature to obtain a convolution transformed feature; and
performing, by using the temporal convolutional layer in the i^{th} spatiotemporal residual component, a temporal convolution operation on the convolution transformed feature to obtain a temporal convolution feature, and obtaining the sample residual feature of the i^{th} spatiotemporal residual component according to the temporal convolution feature and the input data of the i^{th} spatiotemporal residual component.

In one or more embodiments, the i^{th} spatiotemporal attention component in the initial generation model includes a spatial attention sub-component and a temporal attention sub-component; and
the noise prediction module 15, when performing, by using an i^{th} spatiotemporal attention component of the M spatiotemporal attention components, attention processing on the sample text encoding feature and the sample residual feature of the i^{th} spatiotemporal residual component to obtain a sample attention feature of the i^{th} spatiotemporal attention component, is configured to perform the following operations:
performing, by using the spatial attention sub-component in the i^{th} spatiotemporal attention component, spatial attention processing on the sample text encoding feature and the sample residual feature of the i^{th} spatiotemporal residual component to obtain a spatial attention feature; and
performing dimension transformation on the spatial attention feature to obtain an attention transformed feature, and performing, by using the temporal attention sub-component in the i^{th} spatiotemporal attention component, temporal attention processing on the attention transformed feature to obtain the sample attention feature of the i^{th} spatiotemporal attention component.

In one or more embodiments, the noise prediction module 15, when performing, by using the spatial attention sub-component in the i^{th} spatiotemporal attention component, spatial attention processing on the sample text encoding feature and the sample residual feature of the i^{th} spatiotemporal residual component to obtain a spatial attention feature, is configured to perform the following operations:
transforming the sample residual feature of the i^{th} spatiotemporal residual component into a spatial query matrix, a spatial key matrix, and a spatial value matrix according to a transformation weight matrix corresponding to a spatial self-attention layer in the spatial attention sub-component;
performing a dot product operation on the spatial query matrix and a transposed matrix of the spatial key matrix to obtain a first candidate weight matrix, and acquiring a first column quantity corresponding to the spatial query matrix;
normalizing a ratio between the first candidate weight matrix and a square root of the first column quantity to obtain a first attention weight matrix, and obtaining a spatial self-attention feature according to a dot product between the first attention weight matrix and the spatial value matrix;
performing, by using a spatial cross-attention layer in the spatial attention sub-component, an attention operation on the spatial self-attention feature and the sample text encoding feature, to obtain a spatial cross-attention feature; and performing, by using a feedforward network layer in the spatial attention sub-

component, feature transformation on the spatial cross-attention feature to obtain the spatial attention feature.

In one or more embodiments, the noise prediction module 15, when performing, by using the temporal attention sub-component in the i^{th} spatiotemporal attention component, temporal attention processing on the attention transformed feature to obtain the sample attention feature of the i^{th} spatiotemporal attention component, is configured to perform the following operations:
transforming the attention transformation matrix into a temporal query matrix, a temporal key matrix, and a temporal value matrix according to a transformation weight matrix corresponding to a temporal self-attention layer in the temporal attention sub-component;
performing a dot product operation on the temporal query matrix and a transposed matrix of the temporal key matrix to obtain a second candidate weight matrix, and acquiring a second column quantity corresponding to the temporal query matrix;
normalizing a ratio between the second candidate weight matrix and a square root of the second column quantity to obtain a second attention weight matrix, and obtaining a temporal self-attention feature according to a dot product between the second attention weight matrix and the temporal value matrix; and
performing, by using a feedforward network layer in the temporal attention sub-component, feature transformation on the temporal self-attention feature to obtain the sample attention feature of the i^{th} spatiotemporal attention component.

In one or more embodiments, the parameter correction module 16, when correcting a network parameter of the initial generation model according to the sample original noise and the sample predicted noise and determining the initial generation model including the corrected network parameter as a video generation model, is configured to perform the following operations:
acquiring an MSE loss between the sample original noise and the sample predicted noise; and
performing iterative training on the network parameter of the initial generation

model according to the mean square error loss, stopping training until the initial generation model satisfies a training ending condition, and determining the initial generation model at the end of training as the video generation model.

In one or more embodiments, the video generation apparatus 1 further includes: a noise initialization module 17, a text encoding module 18, and a denoising module 19.

The noise initialization module 17 is configured to acquire a video description text, acquire initialized noise, and determine a second step quantity corresponding to the initialized noise.

The text encoding module 18 is configured to perform text encoding processing on the video description text to obtain a video text encoding feature, and input the initialized noise, the video text encoding feature, and second embedding information corresponding to the second step quantity into the video generation model.

The denoising module 19 is configured to perform, by using a j^{th} spatiotemporal residual component in the video generation model, feature extraction on the second embedding information and input data of the j^{th} spatiotemporal residual component to obtain a noise residual feature of the j^{th} spatiotemporal residual component, and perform, by a j^{th} spatiotemporal attention component in the video generation model, attention processing on the video text encoding feature and the noise residual feature of the j^{th} spatiotemporal residual component to obtain a noise attention feature of the j^{th} spatiotemporal attention component; when j is 1, the input data of the j^{th} spatiotemporal residual component including the second embedding information and the initialized noise; and when j is not 1, the input data of the j^{th} spatiotemporal residual component including the video text encoding feature and a noise attention feature of a (j−1)^{th} spatiotemporal attention component.

The denoising module 19 is further configured to determine video predicted noise according to a noise attention feature of an M^{th} spatiotemporal attention component in the video generation model, and perform denoising processing on the initialized noise according to the video predicted noise to obtain noisy video data corresponding to a third step quantity. The third step quantity is less than the second step quantity.

The denoising module 19 is further configured to perform, by using the video generation model, denoising processing on the noisy video data corresponding to the third step quantity until target video data matching the video description text is generated.

In one or more embodiments, the noise attention feature of the M^{th} spatiotemporal attention component in the video generation model includes a noise attention feature under a text condition and a noise attention component under a non-text condition; the noise attention feature under the text condition referring to an attention feature obtained by using the video text encoding feature, and the noise attention feature under the non-text condition referring to an attention feature obtained by using a zeroed video text encoding feature; and
the denoising module 19, when determining video predicted noise according to a noise attention feature of an M^{th} spatiotemporal attention component in the video generation model, is configured to perform the following operations:
generating conditional predicted noise according to the noise attention feature under the text condition, and generating unconditional predicted noise according to the noise attention feature under the non-text condition; and
acquiring a noise difference between the conditional predicted noise and the unconditional predicted noise, and adding the unconditional predicted noise and a product of a noise intensity parameter and the noise difference to obtain the video predicted noise.

According to some embodiments of present disclosure, the operations involved in the video generation method shown in FIG. 3 may be performed by the modules in the video generation apparatus 1 shown in FIG. 12. For example, operation S101 shown in FIG. 3 may be performed by the sample acquisition module 11 shown in FIG. 12, operation S102 shown in FIG. 3 may be performed by the sample noise addition module 12 shown in FIG. 12, operation S103 shown in FIG. 3 may be performed by the model acquisition module 13 shown in FIG. 12, operation S104 shown in FIG. 3 may be performed by the sample input module 14 shown in FIG. 12, operation S105 shown in FIG. 3 may be performed by the noise prediction module 15 shown in FIG. 12, operation S106 shown in FIG. 3 may be performed by the parameter correction module 16 shown in FIG. 12, and so on.

According to some embodiments of present disclosure, the modules of the video generation apparatus 1 shown in FIG. 12 may be separately or wholly combined into one or several modules (or units), or one (or more) of the modules therein may further be divided into at least two smaller units (or sub-units) in terms of function, which can achieve the same operation without affecting the implementation of the technical effects of some embodiments of present disclosure. The foregoing modules are divided based on logical functions. In an actual application, a function of one module may alternatively be implemented by at least two modules, or functions of at least two modules are implemented by one module. In other embodiments of present disclosure, the video generation apparatus 1 may alternatively include other modules. In an actual application, the functions may alternatively be cooperatively implemented by other modules and may be cooperatively implemented by at least two modules.

In this embodiment of present disclosure, in a training phase of the initial generation model, a sample video and a sample description text corresponding to the sample video may be acquired, a sample video frame sequence for training the initial generation model is acquired from the sample video, a first step quantity is randomly sampled, and sample original noise is generated; and noise addition processing is performed on the sample video frame sequence according to the first step quantity and the sample original noise to obtain video input data. The initial generation model may include M spatiotemporal residual components and M spatiotemporal attention components. The M spatiotemporal residual components and the M spatiotemporal attention components are alternately connected. M is an integer greater than 1. The video input data, a sample text encoding feature corresponding to the sample description text, and first embedding information corresponding to the first step quantity are inputted into the initial generation model. Noise prediction is performed on the sample video frame sequence by using the M spatiotemporal residual components and the M spatiotemporal attention components in the initial generation model, to obtain sample predicted noise. The entire initial generation model may be trained by using an MSE loss between the sample predicted noise and the sample original noise. By using the spatiotemporal residual components and the spatiotemporal attention components in the initial generation model, the initial generation model can learn temporal action information in videos of different time scales, improving comprehensiveness of the temporal action information, thereby enhancing quality of video generation.

One or more components of FIG. 12 may be integrated into a single component, or conversely, a single component may be implemented as multiple discrete elements. Additionally or alternatively, different subsets of the illustrated components may be combined in various configurations

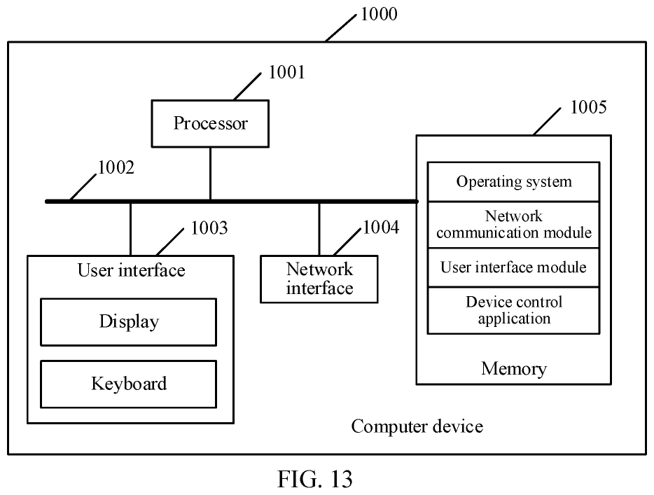

Referring to FIG. 13, FIG. 13 is a schematic structural diagram of a computer device provided by some embodiments of present disclosure. As shown in FIG. 13, the computer device 1000 may be a terminal device, for example, the terminal device 10a in the embodiment corresponding to FIG. 1 above, or may be a server, for example, the server 10d in the embodiment corresponding to FIG. 1 above, which is not limited herein. For ease of understanding, in present disclosure, an example in which the computer device is a terminal device is used. The computer device 1000 may include: a processor 1001, a network interface 1004, and a memory 1005. In addition, the computer device 1000 may further include: a user interface 1003, and at least one communication bus 1002. The communication bus 1002 is configured to implement connection and communication between these components. The user interface 1003 may further include a standard wired interface and a standard wireless interface. In some embodiments, the network interface 1004 may include a standard wired interface and a standard wireless interface (for example, a Wi-Fi interface). The memory 1005 may be a high-speed random access memory (RAM) memory, or may be a non-volatile memory, for example, at least one magnetic disk memory. In some embodiments, the memory 1005 may alternatively be at least one storage apparatus located remotely from the foregoing processor 1001. As shown in FIG. 13, the memory 1005 used as a computer-readable storage medium may include an operating system, a network communication module, a user interface module, and a device control application.

The network interface 1004 in the computer device 1000 may further provide a network communication function, and in some embodiments, the user interface 1003 may further include a display and a keyboard. In the electronic device 1000 shown in FIG. 13, the network interface 1004 may provide a network communication function, the user interface 1003 is mainly configured to provide an input interface for a user, and the processor 1001 may be configured to invoke the device control application stored in the memory 1005, to implement:
acquiring a sample video and a sample description text corresponding to the sample video, acquiring a sample video frame sequence from the sample video, and determining a first step quantity and sample original noise for the sample video frame sequence;
performing data noise addition processing on the sample video frame sequence according to the first step quantity and the sample original noise to obtain video input data, and performing text encoding processing on the sample description text to obtain a sample text encoding feature;
acquiring an initial generation model; the initial generation model including M

spatiotemporal residual components and M spatiotemporal attention components, and the M spatiotemporal residual components and the M spatiotemporal attention components in the initial generation model being alternately connected, M being an integer greater than 1;
inputting the video input data into a first spatiotemporal residual component of

the M spatiotemporal residual components, inputting first embedding information corresponding to the first step quantity into the M spatiotemporal residual components, and inputting the sample text encoding feature into the M spatiotemporal attention components;
performing, in the M spatiotemporal residual components and the M

spatiotemporal attention components, noise prediction on the video input data according to the sample text encoding feature and the first embedding information to obtain sample predicted noise; and
correcting a network parameter of the initial generation model according to the sample original noise and the sample predicted noise, and determining the initial generation model including the corrected network parameter as a video generation model; the video generation model being configured to generate video data matching a video description text.

The computer device 1000 described in this embodiment of present disclosure may implement the descriptions of the video generation method in any one of the foregoing embodiments in FIG. 3, FIG. 7, FIG. 9, and FIG. 11, and may also implement the descriptions of the video generation apparatus 1 in the foregoing embodiment corresponding to FIG. 12. Details are not described herein again. In addition, for descriptions of beneficial effects of using the same method, details are not described herein again.

In addition, herein, some embodiments of present disclosure further provides a computer-readable storage medium. The computer-readable storage medium stores a computer program executed by the video generation apparatus 1 mentioned above, and the computer program includes program instructions. When a processor executes the program instructions, the description of the video generation method in any one of the foregoing embodiments in FIG. 3, FIG. 7, FIG. 9, and FIG. 11 can be executed. Therefore, details are not described herein again. In addition, for descriptions of beneficial effects of using the same method, details are not described herein again. The storage medium may be a magnetic disk, an optical disc, a read-only memory (ROM), a RAM, or the like. For technical details that are not disclosed in some embodiments of the computer-readable storage medium involved in present disclosure, refer to the descriptions of the method embodiments of present disclosure. As an example, the program instructions may be deployed on one computing device, or executed on a plurality of computing devices located at one position, or executed on a plurality of computing devices distributed at a plurality of positions and interconnected by using a communication network, and a blockchain system may be formed by a plurality of computing devices distributed at a plurality of positions and interconnected by using a communication network.

One or more components of FIG. 13 may be integrated into a single component, or conversely, a single component may be implemented as multiple discrete elements. Additionally or alternatively, different subsets of the illustrated components may be combined in various configurations.

In addition, some embodiments of present disclosure further provides a computer program product. The computer program product may include a computer program, and the computer program may be stored in a computer-readable storage medium. A processor of a computer device reads the computer program from the computer-readable storage medium, and the processor may execute the computer program, causing the computer device to execute the foregoing description of the data generation method in any one of the foregoing embodiments in FIG. 3, FIG. 7, FIG. 9, and FIG. 11. Therefore, details are not described herein again. In addition, for descriptions of beneficial effects of using the same method, details are not described herein again. For technical details related to some embodiments of the computer program product or the computer program involved in present disclosure, refer to the description in the method embodiments of present disclosure.

A process, method, apparatus, product, or device that includes a series of operations or units is not limited to the listed operations or modules, and instead, in some embodiments, further includes an operation or module that is not listed, or in some embodiments, further includes another operation or unit that is intrinsic to the process, method, apparatus, product, or device.

A person of ordinary skill in the art may be aware of that, in combination with the examples described in some embodiments disclosed in this present disclosure, units and algorithm steps may be implemented by electronic hardware, computer software, or a combination thereof. To clearly describe interchangeability between the hardware and the software, compositions and operations of each example are generally described in the foregoing descriptions based on functions. Whether the functions are executed by hardware or software depends on particular applications and design constraint conditions of the technical solution. Those skilled in the art may use different methods to implement the described functions for each particular application, but such implementation is not to be considered beyond the scope of present disclosure.

The method and the related apparatus provided in some embodiments of present disclosure are described with reference to the method flowcharts and/or the schematic diagrams of the structures provided in some embodiments of present disclosure. For example, each procedure and/or block in the method flowcharts and/or the schematic diagrams of the structures and a combination of a procedure and/or a block in the flowcharts and/or the block diagrams may be implemented by using computer programs. The computer programs may be provided to a general-purpose computer, a special-purpose computer, an embedded processing machine, or a processor of another programmable data processing device, to generate a machine, so that the computer programs executed by the computer or the processor of the another programmable data processing device generate an apparatus configured to implement the functions specified in one or more processes of the flowcharts and/or one or more blocks of the schematic structural diagrams. The computer programs may alternatively be stored in a computer-readable memory that can guide a computer or another programmable data processing device to operate in a specific manner, so that the computer programs stored in the computer-readable memory generate an artifact including an instruction apparatus. The instruction apparatus implements the functions specified in one or more processes of the flowcharts and/or one or more blocks of the schematic structural diagrams. The computer programs may alternatively be loaded onto a computer or another programmable data processing device, so that a series of operations are performed on the computer or the another programmable device to generate processing implemented by a computer. Therefore, the computer programs executed on the computer or the another programmable device provide operations for implementing the functions specified in one or more processes of the flowcharts and/or one or more blocks of the schematic structural diagrams.

In the embodiment of present disclosure, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processor or memories) may be configured to realize one or more modules or units. In addition, each module or unit may be a part of an overall module or unit including the module or unit function.

The foregoing descriptions are merely exemplary embodiments of present disclosure, and certainly are not intended to limit the protection scope of present disclosure. Therefore, equivalent variations made in accordance with the claims of present disclosure shall fall within the scope of present disclosure.

What is claimed is:

1. A video generation method, performed by a computer device, the video generation method comprising:
acquiring a sample video and a sample description text corresponding to the sample video;
acquiring a sample video frame sequence from the sample video;
determining a first step quantity and sample original noise for the sample video frame sequence;
performing data noise addition processing on the sample video frame sequence based on the first step quantity and the sample original noise, to obtain video input data;
performing text encoding processing on the sample description text, to obtain a sample text encoding feature;
acquiring an initial generation model, the initial generation model comprising M spatiotemporal residual components and M spatiotemporal attention components, and the M spatiotemporal residual components and the M spatiotemporal attention components in the initial generation model being alternately connected, M being an integer greater than 1;
inputting the video input data into a first spatiotemporal residual component of the M spatiotemporal residual components;
inputting first embedding information corresponding to the first step quantity into the M spatiotemporal residual components;
inputting the sample text encoding feature into the M spatiotemporal attention components;
performing, in the M spatiotemporal residual components and the M spatiotemporal attention components, noise prediction on the video input data based on the sample text encoding feature and the first embedding information, to obtain sample predicted noise;
correcting a network parameter of the initial generation model based on the sample original noise and the sample predicted noise; and
determining the initial generation model comprising the corrected network parameter as a video generation model, the video generation model being configured to generate video data matching a video description text.

2. The video generation method according to claim 1, wherein the acquiring of the sample video frame sequence from the sample video comprises:
determining a frame extraction interval duration corresponding to the sample video according to a video frame quantity threshold and a video duration corresponding to the sample video;
acquiring a plurality of video frames from the sample video according to the frame extraction interval duration;
combining the plurality of video frames into an initial video frame sequence; a quantity of video frames comprised in the initial video frame sequence being equal to the video frame quantity threshold; and
acquiring, from the initial video frame sequence, the sample video frame sequence for training the initial generation model, the sample video frame sequence being a subsequence with the quantity of video frames of the initial video frame sequence being less than or equal to the video frame quantity threshold.

3. The video generation method according to claim 1, wherein the determining of the first step quantity and the sample original noise for the sample video frame sequence comprises:
acquiring a diffusion parameter corresponding to the initial generation model;
sampling the first step quantity corresponding to the sample video frame sequence according to the diffusion parameter, the diffusion parameter being configured for representing a total quantity of diffusion steps of the initial generation model, the first step quantity being less than or equal to the diffusion parameter;
generating Gaussian noise having the same dimensions as the sample video frame sequence; and
determining the Gaussian noise as the sample original noise corresponding to the sample video frame sequence.

4. The video generation method according to claim 1, wherein the performing of the data noise addition processing on the sample video frame sequence according to the first step quantity and the sample original noise, to obtain the video input data comprises:
determining a sequence weight corresponding to the sample video frame sequence based on the first step quantity;
determining an original noise weight corresponding to the sample original noise based on the sequence weight, a sum of squares of the sequence weight and the original noise weight being 1; and
adding a product of the sequence weight and the sample video frame sequence to a product of the original noise weight and the sample original noise, to obtain the video input data.

5. The video generation method according to claim 1, wherein the performing of the text encoding processing on the sample description text, to obtain the sample text encoding feature comprises:
dividing the sample description text into D unit characters;
acquiring unit word vectors respectively corresponding to the D unit characters, D being a positive integer;
acquiring text vectors respectively corresponding to the D unit characters based on semantic information of the D unit characters in the sample description text;
acquiring position vectors respectively corresponding to the D unit characters based on text positions of the D unit characters in the sample description text;
combining the unit word vectors, the text vectors, and the position vectors, to obtain an initial text feature corresponding to the sample description text; and
inputting the initial text feature into a text encoder;
performing encoding processing on the initial text feature using the text encoder, to obtain the sample text encoding feature corresponding to the sample description text.

6. The video generation method according to claim 1, wherein the performing of, in the M spatiotemporal residual components and the M spatiotemporal attention components, the noise prediction on the video input data based on the sample text encoding feature and the first embedding information, to obtain the sample predicted noise comprises:
performing, using an i^{th} spatiotemporal residual component of the M spatiotemporal residual components, feature extraction on the first embedding information and input data of the i^{th} spatiotemporal residual component, to obtain a sample residual feature of the i^{th} spatiotemporal residual component, i being a positive integer less than or equal to M;
performing, using an i^{th} spatiotemporal attention component of the M spatiotemporal attention components, attention processing on the sample text encoding feature and the sample residual feature of the i^{th} spatiotemporal residual component, to obtain a sample attention feature of the i^{th} spatiotemporal attention component; and
determining a sample attention feature of a last spatiotemporal attention component of the M spatiotemporal attention components as the sample predicted noise,
wherein the input data of the i^{th} spatiotemporal residual component comprises the video input data and the first embedding information based on i being 1, and
wherein the input data of the i^{th} spatiotemporal residual component comprises the first embedding information and a sample attention feature of an (i−1)^{th} spatiotemporal attention component based on i not being 1.

7. The video generation method according to claim 6, wherein the i^{th} spatiotemporal residual component comprises a spatial convolutional layer and a temporal convolutional layer,
wherein the input data of the i^{th} spatiotemporal residual component further comprises the sample residual feature of a spatiotemporal residual component symmetrically positioned with respect to the i^{th} spatiotemporal residual component in the initial generation model, based on i being greater than M/2+1, and
wherein the performing of, using the i^{th} spatiotemporal residual component of the M spatiotemporal residual components, the feature extraction on the first embedding information and the input data of the i^{th} spatiotemporal residual component, to obtain the sample residual feature of the i^{th} spatiotemporal residual component comprises:
adding the first embedding information and the input data of the i^{th} spatiotemporal residual component, to obtain a combined input feature;
performing, using the spatial convolutional layer in the i^{th} spatiotemporal residual component, a spatial convolution operation on the combined input feature, to obtain a spatial convolution feature;
performing dimension transformation on the spatial convolution feature, to obtain a convolution transformed feature;
performing, using the temporal convolutional layer in the i^{th} spatiotemporal residual component, a temporal convolution operation on the convolution transformed feature, to obtain a temporal convolution feature; and
obtaining the sample residual feature of the i^{th} spatiotemporal residual component based on the temporal convolution feature and the input data of the i^{th} spatiotemporal residual component.

8. The video generation method according to claim 6, wherein the i^{th} spatiotemporal attention component comprises a spatial attention sub-component and a temporal attention sub-component, and
wherein the performing of, using the i^{th} spatiotemporal attention component of the M spatiotemporal attention components, the attention processing on the sample text encoding feature and the sample residual feature of the i^{th} spatiotemporal residual component, to obtain the sample attention feature of the i^{th} spatiotemporal attention component comprises:
performing, using the spatial attention sub-component in the i^{th} spatiotemporal attention component, spatial attention processing on the sample text encoding feature and the sample residual feature of the i^{th} spatiotemporal residual component, to obtain a spatial attention feature;
performing dimension transformation on the spatial attention feature, to obtain an attention transformed feature; and
performing, using the temporal attention sub-component in the i^{th} spatiotemporal attention component, temporal attention processing on the attention transformed feature, to obtain the sample attention feature of the i^{th} spatiotemporal attention component.

9. The video generation method according to claim 8, wherein the performing of, using the spatial attention sub-component in the i^{th} spatiotemporal attention component, the spatial attention processing on the sample text encoding feature and the sample residual feature of the i^{th} spatiotemporal residual component, to obtain a spatial attention feature comprises:
transforming the sample residual feature of the i^{th} spatiotemporal residual component into a spatial query matrix, a spatial key matrix, and a spatial value matrix based on a transformation weight matrix corresponding to a spatial self-attention layer in the spatial attention sub-component;
performing a dot product operation on the spatial query matrix and a transposed matrix of the spatial key matrix, to obtain a first candidate weight matrix;
acquiring a first column quantity corresponding to the spatial query matrix;
normalizing a ratio between the first candidate weight matrix and a square root of the first column quantity, to obtain a first attention weight matrix;
obtaining a spatial self-attention feature based on a dot product between the first attention weight matrix and the spatial value matrix;
performing, using a spatial cross-attention layer in the spatial attention sub-component, an attention operation on the spatial self-attention feature and the sample text encoding feature, to obtain a spatial cross-attention feature; and
performing, using a feedforward network layer in the spatial attention sub-component, feature transformation on the spatial cross-attention feature, to obtain the spatial attention feature.

10. The video generation method according to claim 8, wherein the performing of, using the temporal attention sub-component in the i^{th} spatiotemporal attention component, the temporal attention processing on the attention transformed feature, to obtain the sample attention feature of the i^{th} spatiotemporal attention component comprises:
transforming attention transformation matrix into a temporal query matrix, a temporal key matrix, and a temporal value matrix based on a transformation weight matrix corresponding to a temporal self-attention layer in the temporal attention sub-component;
performing a dot product operation on the temporal query matrix and a transposed matrix of the temporal key matrix, to obtain a second candidate weight matrix;
acquiring a second column quantity corresponding to the temporal query matrix;
normalizing a ratio between the second candidate weight matrix and a square root of the second column quantity, to obtain a second attention weight matrix;
obtaining a temporal self-attention feature based on a dot product between the second attention weight matrix and the temporal value matrix; and
performing, using a feedforward network layer in the temporal attention sub-component, feature transformation on the temporal self-attention feature, to obtain the sample attention feature of the i^{th} spatiotemporal attention component.

11. The video generation method according to claim 1, wherein the correcting of the network parameter of the initial generation model based on the sample original noise and the sample predicted noise; and determining of the initial generation model comprising the corrected network parameter as the video generation model comprises:
acquiring a mean squared error (MSE) loss between the sample original noise and the sample predicted noise;
performing iterative training on the corrected network parameter of the initial generation model based on the MSE loss;
stopping training until the initial generation model meets a training ending condition; and
determining the initial generation model at the end of training as the video generation model.

12. The video generation method according to claim 1, wherein the method further comprises:
acquiring the video description text and initialized noise;
determining a second step quantity corresponding to the initialized noise;
performing text encoding processing on the video description text, to obtain a video text encoding feature;
inputting the initialized noise, the video text encoding feature, and second embedding information corresponding to the second step quantity into the video generation model;
performing, using a j^{th} spatiotemporal residual component in the video generation model, feature extraction on the second embedding information and input data of the j^{th} spatiotemporal residual component, to obtain a noise residual feature of the j^{th} spatiotemporal residual component;
performing, using a j^{th} spatiotemporal attention component in the video generation model, the attention processing on the video text encoding feature and the noise residual feature of the j^{th} spatiotemporal residual component, to obtain a noise attention feature of the j^{th} spatiotemporal attention component,
wherein the input data of the j^{th} spatiotemporal residual component comprises the second embedding information and the initialized noise, based on j being 1, wherein the input data of the j^{th} spatiotemporal residual component comprising the video text encoding feature and a noise attention feature of a (j−1)^{th} spatiotemporal attention component, j being a positive integer less than or equal to M, based on j not being 1, and
wherein the video generation method further comprises:
determining video predicted noise based on a noise attention feature of an M^{th} spatiotemporal attention component in the video generation model;
performing denoising processing on the initialized noise based on the video predicted noise and the second step quantity, to obtain noisy video data corresponding to a third step quantity, the third step quantity being less than the second step quantity; and
performing, using the video generation model, denoising processing on the noisy video data corresponding to the third step quantity until target video data matching the video description text is generated.

13. The video generation method according to claim 12, wherein the noise attention feature of the M^{th} spatiotemporal attention component in the video generation model comprises a noise attention feature under a text condition and a noise attention component under a non-text condition,
wherein the noise attention feature under the text condition is obtained using the video text encoding feature,
wherein the noise attention feature under the non-text condition is obtained using a zeroed video text encoding feature, and
wherein the determining of the video predicted noise based on a noise attention feature of an M^{th} spatiotemporal attention component in the video generation model comprises:
generating conditional predicted noise based on the noise attention feature under the text condition;
generating unconditional predicted noise based on the noise attention feature under the non-text condition;
acquiring a noise difference between the conditional predicted noise and the unconditional predicted noise; and
adding the unconditional predicted noise and a product of a noise intensity parameter and the noise difference, to obtain the video predicted noise.

14. A video generation apparatus, comprising:
at least one memory configured to store computer program code; and at least one processor configured to read the program code and operate as instructed by the program code, the program code comprising:
sample acquisition code configured to cause the at least one processor to:
acquire a sample video and a sample description text corresponding to the sample video;
acquire a sample video frame sequence from the sample video; and
determine a first step quantity and sample original noise for the sample video frame sequence;
sample noise addition code configured to cause the at least one processor to:
perform data noise addition processing on the sample video frame sequence based on the first step quantity and the sample original noise, to obtain video input data; and
perform text encoding processing on the sample description text, to obtain a sample text encoding feature;
model acquisition code configured to cause the at least one processor to acquire an initial generation model, the initial generation model comprising M spatiotemporal residual components and M spatiotemporal attention components, and the M spatiotemporal residual components and the M spatiotemporal attention components in the initial generation model being alternately connected, M being an integer greater than 1;
sample input code configured to cause the at least one processor to:
input the video input data into a first spatiotemporal residual component of the M spatiotemporal residual components;
input first embedding information corresponding to the first step quantity into the M spatiotemporal residual components; and
input the sample text encoding feature into the M spatiotemporal attention components;
noise prediction code configured to cause the at least one processor to perform, in the M spatiotemporal residual components and the M spatiotemporal attention components, noise prediction on the video input data based on the sample text encoding feature and the first embedding information to obtain sample predicted noise; and
parameter correction code configured to cause the at least one processor to:
correct a network parameter of the initial generation model based on the sample original noise and the sample predicted noise; and
determine the initial generation model comprising the corrected network parameter as a video generation model; the video generation model being configured to generate video data matching a video description text.

15. The video generation apparatus according to claim 14, wherein the sample acquisition code is further configured to cause the at least one processor to:
determine a frame extraction interval duration corresponding to the sample video according to a video frame quantity threshold and a video duration corresponding to the sample video;
acquire a plurality of video frames from the sample video according to the frame extraction interval duration;
combine the plurality of video frames into an initial video frame sequence; a quantity of video frames comprised in the initial video frame sequence being equal to the video frame quantity threshold; and
acquire, from the initial video frame sequence, the sample video frame sequence for training the initial generation model, the sample video frame sequence being a subsequence with the quantity of video frames of the initial video frame sequence being less than or equal to the video frame quantity threshold.

16. The video generation apparatus according to claim 14, wherein the sample acquisition code is further configured to cause the at least one processor to:
acquire a diffusion parameter corresponding to the initial generation model;
sample the first step quantity corresponding to the sample video frame sequence according to the diffusion parameter, the diffusion parameter being configured for representing a total quantity of diffusion steps of the initial generation model, the first step quantity being less than or equal to the diffusion parameter;
generate Gaussian noise having the same dimensions as the sample video frame sequence; and
determine the Gaussian noise as the sample original noise corresponding to the sample video frame sequence.

17. The video generation apparatus according to claim 14, wherein the sample noise addition code is further configured to cause the at least one processor to:
determine a sequence weight corresponding to the sample video frame sequence based on the first step quantity;
determine an original noise weight corresponding to the sample original noise based on the sequence weight, a sum of squares of the sequence weight and the original noise weight being 1; and
add a product of the sequence weight and the sample video frame sequence to a product of the original noise weight and the sample original noise, to obtain the video input data.

18. The video generation apparatus according to claim 14, wherein the sample noise addition code is further configured to cause the at least one processor to:
divide the sample description text into D unit characters;
acquire unit word vectors respectively corresponding to the D unit characters, D being a positive integer;
acquire text vectors respectively corresponding to the D unit characters based on semantic information of the D unit characters in the sample description text;
acquire position vectors respectively corresponding to the D unit characters based on text positions of the D unit characters in the sample description text;
combine the unit word vectors, the text vectors, and the position vectors, to obtain an initial text feature corresponding to the sample description text; and
input the initial text feature into a text encoder;
perform encoding processing on the initial text feature using the text encoder, to obtain the sample text encoding feature corresponding to the sample description text.

19. The video generation apparatus according to claim 14, wherein the noise prediction code is further configured to cause the at least one processor to:
perform, using an i^{th} spatiotemporal residual component of the M spatiotemporal residual components, feature extraction on the first embedding information and input data of the i^{th} spatiotemporal residual component, to obtain a sample residual feature of the i^{th} spatiotemporal residual component, i being a positive integer less than or equal to M;
perform, using an i^{th} spatiotemporal attention component of the M spatiotemporal attention components, attention processing on the sample text encoding feature and the sample residual feature of the i^{th} spatiotemporal residual component, to obtain a sample attention feature of the i^{th} spatiotemporal attention component; and
determine a sample attention feature of a last spatiotemporal attention component of the M spatiotemporal attention components as the sample predicted noise,
wherein the input data of the i^{th} spatiotemporal residual component comprises the video input data and the first embedding information based on i being 1, and
wherein the input data of the i^{th} spatiotemporal residual component comprises the first embedding information and a sample attention feature of an (i−1)^{th} spatiotemporal attention component based on i not being 1.

20. A non-transitory computer-readable storage medium, storing computer program code, when executed by at least one processor, causes the at least one processor to at least:
acquire a sample video and a sample description text corresponding to the sample video;
acquire a sample video frame sequence from the sample video;
determine a first step quantity and sample original noise for the sample video frame sequence;
perform data noise addition processing on the sample video frame sequence based on the first step quantity and the sample original noise, to obtain video input data;
perform text encoding processing on the sample description text, to obtain a sample text encoding feature;
acquire an initial generation model, the initial generation model comprising M spatiotemporal residual components and M spatiotemporal attention components, and the M spatiotemporal residual components and the M spatiotemporal attention components in the initial generation model being alternately connected, M being an integer greater than 1;
input the video input data into a first spatiotemporal residual component of the M spatiotemporal residual components;
input first embedding information corresponding to the first step quantity into the M spatiotemporal residual components;
input the sample text encoding feature into the M spatiotemporal attention components;
perform, in the M spatiotemporal residual components and the M spatiotemporal attention components, noise prediction on the video input data based on the sample text encoding feature and the first embedding information, to obtain sample predicted noise;
correct a network parameter of the initial generation model based on the sample original noise and the sample predicted noise; and
determine the initial generation model comprising the corrected network parameter as a video generation model, the video generation model being configured to generate video data matching a video description text.
